(19) United States
(12) Patent Application Publication
(10) Pub. No.: US 2026/0039549 A1
(43) Pub. Date: Feb. 5, 2026

(54) NODE IN WIRELESS COMMUNICATION SYSTEM AND METHOD PERFORMED BY THE SAME

(71) Applicant: Samsung Electronics Co., Ltd., Gyeonggi-do (KR)

(72) Inventors: Yanru WANG, Beijing (CN); Lixiang XU, Beijing (CN); Hong WANG, Beijing (CN); Weiwei WANG, Beijing (CN)

(21) Appl. No.: 19/100,770

(22) PCT Filed: Aug. 1, 2023
(86) PCT No.: PCT/KR2023/011208

§ 371 Date: Feb. 3, 2025

(30) Foreign Application Priority Data
Aug. 3, 2022 (CN) 202210929481.9
Sep. 23, 2022 (CN) 202211167826.8
Jun. 30, 2023 (CN) 202310802039.4

(51) Int. Cl. H04L 41/0823; H04W 8/22; H04W 84/04

(52) U.S. Cl. CPC H04L 41/0823; H04W 8/22; H04W 84/042

(57) ABSTRACT

The disclosure relates to a 5G or 6G communication system for supporting a higher data transmission rate. The present disclosure provides a node in a wireless communication system and methods performed by the same, one of the methods may include: receiving, from a second node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, and twelfth information including NPN information of an NPN associated with the second node and/or a third node; performing a network self-optimization decision based on the at least one piece of information, and/or transmitting the at least one piece of information to other nodes; wherein the third node is at least one of other nodes except the second node.

### TECHNICAL FIELD

The present disclosure relates to a technical field of wireless communication, and more specifically, to a node in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to node in a wireless communication systems.

### Solution to Problem

Embodiments of the present disclosure provide a method performed by a first node in a wireless communication system, including: receiving, from a second node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, twelfth information including NPN information of an NPN associated with the second node and/or a third node, and fourteenth information including an NPN function activation result of the second node; performing a network self-optimization decision based on the at least one piece of information, and/or transmitting the at least one piece of information to other nodes; wherein the third node is at least one of other nodes except the second node in the wireless communication system.

Embodiments of the present disclosure provide a method performed by a second node in a wireless communication system, including: transmitting, to a first node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, twelfth information including NPN information of an NPN associated with the second node and/or a third node, and fourteenth information including an NPN function activation result of the second node, wherein the third node is at least one of other nodes except the second node in the wireless communication system.

Embodiments of the present disclosure provides a first node device in a wireless communication system, including a transceiver configured to transmit and receive signals; and a processor coupled to the transceiver and configured to perform methods performed by a first node in a wireless communication system according to embodiments of the present disclosure.

Embodiments of the present disclosure provides a second node device in a wireless communication system, including a transceiver configured to transmit and receive signals; and a processor coupled to the transceiver and configured to perform methods performed by a second node in a wireless communication system according to embodiments of the present disclosure.

Embodiments of the present disclosure provide a computer-readable medium having stored thereon computer-readable instructions which, when executed by a processor, implement methods performed by a first node and/or a second node in a wireless communication system according to embodiments of the present disclosure.

The methods performed by a first node and/or a second node in a wireless communication system provided by the present disclosure enables self-optimization decisions to be made or configuration to be updated at the network side by exchanging information related to the non-public network between nodes.

### Advantageous Effects of Invention

According to an embodiment of the disclosure, a wireless communication can be performed efficiently.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 is an exemplary system architecture 100 of System Architecture Evolution (SAE);

FIG. 2 is an exemplary system architecture 200 according to various embodiments of the present disclosure;

FIG. 3 illustrates a flowchart of a method 300 performed by a first node in a wireless communication system according to embodiments of the present disclosure;

FIG. 4 illustrates a flowchart of a method 400 performed by a second node in a wireless communication system according to embodiments of the present disclosure;

FIG. 5A illustrates a schematic diagram of an aspect of a method for supporting non-public network self-optimization according to embodiments of the present disclosure;

FIG. 5B illustrates a schematic diagram of an aspect of a method for supporting non-public network self-optimization according to embodiments of the present disclosure;

FIG. 6A illustrates a schematic diagram of an aspect of a method for supporting non-public network self-optimization according to embodiments of the present disclosure;

FIG. 6B illustrates a schematic diagram of an aspect of a method for supporting non-public network self-optimization according to embodiments of the present disclosure;

FIG. 6C illustrates a schematic diagram of an aspect of a method for supporting non-public network self-optimization according to embodiments of the present disclosure;

FIG. 7A illustrates a schematic diagram of an aspect of a method for supporting non-public network self-optimization according to embodiments of the present disclosure;

FIG. 7B illustrates a schematic diagram of an aspect of a method for supporting non-public network self-optimization according to embodiments of the present disclosure;

FIG. 7C illustrates a schematic diagram of an aspect of a method for supporting non-public network self-optimization according to embodiments of the present disclosure;

FIG. 8A illustrates a schematic diagram of an aspect of a method for supporting non-public network self-optimization according to embodiments of the present disclosure;

FIG. 8B illustrates a schematic diagram of an aspect of a method for supporting non-public network self-optimization according to embodiments of the present disclosure;

FIG. 9A illustrates a schematic diagram of an aspect of a method for supporting non-public network self-optimization according to embodiments of the present disclosure;

FIG. 9B illustrates a schematic diagram of an aspect of a method for supporting non-public network self-optimization according to embodiments of the present disclosure;

FIG. 9C illustrates a schematic diagram of an aspect of a method for supporting non-public network self-optimization according to embodiments of the present disclosure;

FIG. 9D illustrates a schematic diagram of an aspect of a method for supporting non-public network self-optimization according to embodiments of the present disclosure;

FIG. 9E illustrates a schematic diagram of an aspect of a method for supporting non-public network self-optimization according to embodiments of the present disclosure;

FIG. 9F illustrates a schematic diagram of an aspect of a method for supporting non-public network self-optimization according to embodiments of the present disclosure;

FIG. 9G illustrates a schematic diagram of an aspect of a method for supporting non-public network self-optimization according to embodiments of the present disclosure;

FIG. 10 illustrates a schematic diagram of a first node 1000 according to embodiments of the present disclosure;

FIG. 11 illustrates a schematic diagram of a second node 1100 according to embodiments of the present disclosure;

FIG. 12A illustrates a schematic diagram of an aspect of a method for supporting non-public network self-optimization according to embodiments of the present disclosure; and

FIG. 12B illustrates a schematic diagram of an aspect of a method for supporting non-public network self-optimization according to embodiments of the present disclosure.

### MODE FOR THE INVENTION

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

Non-Public Network (NPN) is a network that provides services for specific users, which is different from a public network. Generally, it may include the following two types:
Standalone NPN network (SNPN), which is independent of PLMN network and is operated by SNPN operators.
Non-standalone NPN network (Public network integrated NPN, PNI-NPN), which depends on PLMN network and is operated by traditional operators.

SNPN supports UE to access SNPN using a credential obtained from a Credentials Holder (CH) other than SNPN. SNPN supports UE to access an Onboarding Network in order to provide the credential of SNPN to the UE for initial authentication, so that the UE can access a target/desired SNPN.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Embodiments of the present disclosure provide a method performed by a first node in a wireless communication system, including: receiving, from a second node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, twelfth information including NPN information of an NPN associated with the second node and/or a third node, and fourteenth information including an NPN function activation result of the second node; performing a network self-optimization decision based on the at least one piece of information, and/or transmitting the at least one piece of information to other nodes; wherein the third node is at least one of other nodes except the second node in the wireless communication system.

According to embodiments of the present disclosure, the method performed by a first node in a wireless communication system further includes: before receiving the at least one piece of information from the second node, transmitting first information including a request for non-public network (NPN) support capability information of the second node and/or a third node to the second node, wherein the second information is transmitted to the first node by the second node based on the first information, wherein the first information includes one or more of the following: transmitting node identification, receiving node identification, NPN identification corresponding to requested information, content requested for reporting, reporting type, reporting registration request, reporting interval and trigger event.

According to embodiments of the present disclosure, the method performed by a first node in a wireless communication system further includes: before receiving the at least one piece of information from the second node, transmitting third information including a request for the NPN access requirement information of a user equipment (UE) to the second node, wherein the fourth information is transmitted to the first node by the second node based on the third information, wherein the third information includes one or more of the following: transmitting node identification, receiving node identification, UE identification, reporting registration request, and NPN access requirement content requested to be reported.

According to embodiments of the present disclosure, the method performed by a first node in a wireless communication system further includes: before receiving the at least one piece of information from the second node, transmitting fifth information including a request for the NPN support capability information of neighboring cells of the second node and/or a third node and/or extra NPN support capability information of the second node and/or a third node to the second node, wherein the sixth information is transmitted to the first node by the second node based on the fifth information, wherein the fifth information includes one or more of the following: transmitting node identification, receiving node identification, NPN support capability information of neighboring cells and/or neighboring nodes requested to be reported, NPN identification corresponding to information requested to be reported, extra NPN support capability information requested to be reported, reporting type, reporting registration request, reporting interval and trigger event.

According to embodiments of the present disclosure, the method performed by a first node in a wireless communication system further includes: before receiving the at least one piece of information from the second node, transmitting seventh information including a request for the resource status and/or load situation of an NPN associated with the second node and/or a third node to the second node, and receiving eighth information including a response to the request for the resource status and/or load situation of an NPN associated with the second node and/or a third node from the second node, wherein the ninth information is transmitted to the first node by the second node based on the seventh information, wherein the seventh information includes one or more of the following: transmitting node identification, receiving node identification, NPN identification, requested content, reporting type, reporting registration request, reporting interval, trigger event, and wherein the eighth information includes one or more of the following: transmitting node identification, receiving node identification, NPN identification corresponding to the information that can be reported, content that can be reported, NPN identification corresponding to information that can not be reported, content that can not be reported, and cause for request failure.

According to embodiments of the present disclosure, the method performed by a first node in a wireless communication system further includes: before receiving the at least one piece of information from the second node, transmitting eleventh information including a request for the NPN information of an NPN associated with the second node and/or a third node to the second node, wherein the twelfth information is transmitted to the first node by the second node based on the eleventh information, wherein the eleventh information includes one or more of the following: UE identification, transmitting node identification, receiving node identification, NPN information request, NPN report request, NPN failure information request and NPN failure report request, NPN identification corresponding to report requested to be reported, NPN identification corresponding to information requested to be reported, indication of request for reporting report that is about to time out and/or be discarded, indication of request for reporting information that is about to time out and/or be discarded, request for reporting report corresponding to a specific time, request for reporting information corresponding to a specific time, request for reporting report corresponding to a specific configuration, request for reporting information corresponding to a specific configuration.

According to embodiments of the present disclosure, the method performed by a first node in a wireless communication system further includes: before transmitting eleventh information including a request for the NPN information of an NPN associated with the second node and/or a third node to the second node, receiving tenth information used for indicating that the NPN information of an NPN associated with the second node and/or a third node is available from the second node, wherein the eleventh information is transmitted by the first node to the second node based on the tenth information, wherein the tenth information includes one or more of the following: UE identification, transmitting node identification, receiving node identification, NPN information available, NPN report available, NPN failure information available, and NPN failure report available, NPN identification corresponding to NPN report, NPN identification corresponding to NPN failure report, NPN identification corresponding to NPN information, NPN identification corresponding to NPN failure information, identification of that NPN report is about to time out and/or be discarded, identification of that NPN failure report is about to time out and/or be discarded, identification of that NPN information is about to time out and/or be discarded, identification of that NPN failure information is about to time out and/or be discarded, time corresponding to NPN report, time corresponding to NPN failure report, time corresponding to NPN information, time corresponding to NPN failure information, configuration corresponding to NPN report, configuration corresponding to NPN failure report, configuration corresponding to NPN information, configuration corresponding to NPN failure information.

According to embodiments of the present disclosure, the method performed by a first node in a wireless communication system further includes: before receiving the at least one piece of information from the second node, transmitting thirteenth information including an NPN function activation request to the second node, wherein the fourteenth information is transmitted to the first node by the second node based on the thirteenth information, wherein the thirteenth information includes one or more of the following: transmitting node identification, receiving node identification, activation request identification, NPN identification, request to activate an onboarding function, request to activate a function of performing access using a credential obtained from a credential holder, cause for requesting for activation.

According to embodiments of the present disclosure, the fourteenth information includes one or more of the following: transmitting node identification, receiving node identification, activation request identification, successfully activated NPN identification, identification of an NPN for which an onboarding function is successfully activated, identification of an NPN for which a function of performing access using a credential obtained from a credential holder is successfully activated, identification of successful activation of an onboarding function, identification of successful activation of a function of performing access using a credential obtained from a credential holder, time of successful activation, identification of an NPN with failed activation, identification of an NPN for which activation of an onboarding function is failed, identification of an NPN for which activation of a function of performing access using a credential obtained from a credential holder is failed, identification of failed activation of an onboarding function, identification of failed activation of a function of performing access using a credential obtained from a credential holder, time of activation failure, cause for successful activation, cause for activation failure.

According to embodiments of the present disclosure, the at least one piece of information is used for at least one of the first node, the second node and other nodes to perform a network self-optimization decision, wherein the network self-optimization decision includes at least one of network energy saving, load balancing, coverage optimization, mobility optimization and/or management, network configuration determination and/or network configuration updating.

According to embodiments of the present disclosure, the second information includes one or more of the following: transmitting node identification, receiving node identification, NPN identification, onboarding support identification, identification about that access can be performed using a credential obtained from a credential holder, group identifications for network selection, indication of whether an NPN has a capability to support onboarding, indication of whether an NPN has a capability of that access can be performed using a credential obtained from a credential holder, indication of whether onboarding support is enabled, indication of whether that access can be performed using a credential obtained from a credential holder is enabled, trigger event, and cause why NPN support capability information cannot be reported.

According to embodiments of the present disclosure, the fourth information includes one or more of the following: transmitting node identification, receiving node identification, UE identification, NPN identification, cause for UE to access NPN, whether to need onboarding, whether to support onboarding, whether to need access using a credential obtained from a credential holder, whether to support access using a credential obtained from a credential holder, purpose for UE to access NPN, onboarding request, request for performing access using a credential obtained from a credential holder, identification of a target NPN and/or desired NPN, group identifications for network selection and/or list of group identifications for network selection corresponding to a network accessed by UE, and cause why NPN access requirement information of a UE cannot be reported.

According to embodiments of the present disclosure, the sixth information includes one or more of the following: transmitting node identification, receiving node identification, NPN support capability information of neighboring cells and/or neighboring nodes, supported NPN identification, extra onboarding support identification, identification of extra support for performing access using a credential obtained from a credential holder, group identifications for network selection corresponding to extra support, and trigger event.

According to embodiments of the present disclosure, the ninth information includes one or more of the following: transmitting node identification, receiving node identification, NPN identification corresponding to reported information, reporting content and trigger event.

According to embodiments of the present disclosure, the twelfth information includes one or more of the following: UE identification, node identification, cell identification, NPN identification, time from access to reporting, time from access failure to reporting, time from access attempt to reporting, time from handover to reporting, cause for UE to access NPN, purpose for UE to access and/or register NPN, way for accessing and/or registering NPN, reconnected NPN identification, reconnected cell identification, indication of whether to handover from an NPN to an ordinary cell, indication of whether to handover from an ordinary cell to an NPN, group identifications for network selection, group identifications for network selection of an accessing cell, group identifications for network selection of a neighboring cell, identification of a target NPN and/or desired NPN, network selection mode, cause for access and/or handover failure and/or cause for failure to provide service.

Embodiments of the present disclosure provide a method performed by a second node in a wireless communication system, including: transmitting, to a first node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, twelfth information including NPN information of an NPN associated with the second node and/or a third node, and fourteenth information including an NPN function activation result of the second node, wherein the third node is at least one of other nodes except the second node in the wireless communication system.

According to embodiments of the present disclosure, the method performed by a second node in a wireless communication system further includes: before transmitting the at least one piece of information to the first node, receiving first information including a request for non-public network (NPN) support capability information of the second node and/or a third node from the first node, wherein the second information is transmitted to the first node by the second node based on the first information, wherein the first information includes one or more of the following: transmitting node identification, receiving node identification, NPN identification corresponding to requested information, content requested for reporting, reporting type, reporting registration request, reporting interval and trigger event.

According to embodiments of the present disclosure, the method performed by a second node in a wireless communication system further includes: before transmitting the at least one piece of information to the first node, receiving third information including a request for the NPN access requirement information of a user equipment (UE) from the first node, wherein the fourth information is transmitted to the first node by the second node based on the third information, wherein the third information includes one or more of the following: transmitting node identification, receiving node identification, UE identification, reporting registration request, and NPN access requirement content requested to be reported.

According to embodiments of the present disclosure, the method performed by a second node in a wireless communication system further includes: before transmitting the at least one piece of information to the first node, receiving fifth information including a request for the NPN support capability information of neighboring cells of the second node and/or a third node and/or extra NPN support capability information of the second node and/or a third node from the first node, wherein the sixth information is transmitted to the first node by the second node based on the fifth information, wherein the fifth information includes one or more of the following: transmitting node identification, receiving node identification, NPN support capability information of neighboring cells and/or neighboring nodes requested to be reported, NPN identification corresponding to information requested to be reported, extra NPN support capability information requested to be reported, reporting type, reporting registration request, reporting interval and trigger event.

According to embodiments of the present disclosure, the method performed by a second node in a wireless communication system further includes: before transmitting the at least one piece of information to the first node, receiving seventh information including a request for the resource status and/or load situation of an NPN associated with the second node and/or a third node from the first node, and transmitting eighth information including a response to the request for the resource status and/or load situation of an NPN associated with the second node and/or a third node to the first node, wherein the ninth information is transmitted to the first node by the second node based on the seventh information, wherein the seventh information includes one or more of the following: transmitting node identification, receiving node identification, NPN identification, requested content, reporting type, reporting registration request, reporting interval, trigger event, and wherein the eighth information includes one or more of the following: transmitting node identification, receiving node identification, NPN identification corresponding to the information that can be reported, content that can be reported, NPN identification corresponding to information that can not be reported, content that can not be reported, and cause for request failure.

According to embodiments of the present disclosure, the method performed by a second node in a wireless communication system further includes: before transmitting the at least one piece of information to the first node, receiving eleventh information including a request for the NPN information of an NPN associated with the second node and/or a third node from the first node, wherein the twelfth information is transmitted to the first node by the second node based on the eleventh information, wherein the eleventh information includes one or more of the following: UE identification, transmitting node identification, receiving node identification, NPN information request, NPN report request, NPN failure information request and NPN failure report request, NPN identification corresponding to report requested to be reported, NPN identification corresponding to information requested to be reported, indication of request for reporting report that is about to time out and/or be discarded, indication of request for reporting information that is about to time out and/or be discarded, request for reporting report corresponding to a specific time, request for reporting information corresponding to a specific time, request for reporting report corresponding to a specific configuration, request for reporting information corresponding to a specific configuration.

According to embodiments of the present disclosure, the method performed by a second node in a wireless communication system further includes: before receiving eleventh information including a request for the NPN information of an NPN associated with the second node and/or a third node from the first node, transmitting tenth information used for indicating that the NPN information of an NPN associated with the second node and/or a third node is available to the first node, wherein the eleventh information is transmitted by the first node to the second node based on the tenth information, wherein the tenth information includes one or more of the following: UE identification, transmitting node identification, receiving node identification, NPN information available, NPN report available, NPN failure information available, and NPN failure report available, NPN identification corresponding to NPN report, NPN identification corresponding to NPN failure report, NPN identification corresponding to NPN information, NPN identification corresponding to NPN failure information, identification of that NPN report is about to time out and/or be discarded, identification of that NPN failure report is about to time out and/or be discarded, identification of that NPN information is about to time out and/or be discarded, identification of that NPN failure information is about to time out and/or be discarded, time corresponding to NPN report, time corresponding to NPN failure report, time corresponding to NPN information, time corresponding to NPN failure information, configuration corresponding to NPN report, configuration corresponding to NPN failure report, configuration corresponding to NPN information, configuration corresponding to NPN failure information.

According to embodiments of the present disclosure, the method performed by a second node in a wireless communication system further includes: before transmitting the at least one piece of information to the first node, receiving thirteenth information including an NPN function activation request from the first node, wherein the fourteenth information is transmitted to the first node by the second node based on the thirteenth information, wherein the thirteenth information includes one or more of the following: transmitting node identification, receiving node identification, activation request identification, NPN identification, request to activate an onboarding function, request to activate a function of performing access using a credential obtained from a credential holder, cause for requesting for activation.

According to embodiments of the present disclosure, the fourteenth information includes one or more of the following: transmitting node identification, receiving node identification, activation request identification, successfully activated NPN identification, identification of an NPN for which an onboarding function is successfully activated, identification of an NPN for which a function of performing access using a credential obtained from a credential holder is successfully activated, identification of successful activation of an onboarding function, identification of successful activation of a function of performing access using a credential obtained from a credential holder, time of successful activation, identification of an NPN with failed activation, identification of an NPN for which activation of an onboarding function is failed, identification of an NPN for which activation of a function of performing access using a credential obtained from a credential holder is failed, identification of failed activation of an onboarding function, identification of failed activation of a function of performing access using a credential obtained from a credential holder, time of activation failure, cause for successful activation, cause for activation failure.

According to embodiments of the present disclosure, the at least one piece of information is used for at least one of the first node, the second node and other nodes to perform a network self-optimization decision, wherein the network self-optimization decision includes at least one of network energy saving, load balancing, coverage optimization, mobility optimization and/or management, network configuration determination and/or network configuration updating.

According to embodiments of the present disclosure, the second information includes one or more of the following: transmitting node identification, receiving node identification, NPN identification, onboarding support identification, identification about that access can be performed using a credential obtained from a credential holder, group identifications for network selection, indication of whether an NPN has a capability to support onboarding, indication of whether an NPN has a capability of that access can be performed using a credential obtained from a credential holder, indication of whether onboarding support is enabled, indication of whether that access can be performed using a credential obtained from a credential holder is enabled, trigger event, and cause why NPN support capability information cannot be reported.

According to embodiments of the present disclosure, the fourth information includes one or more of the following: transmitting node identification, receiving node identification, UE identification, NPN identification, cause for UE to access NPN, whether to need onboarding, whether to support onboarding, whether to need access using a credential obtained from a credential holder, whether to support access using a credential obtained from a credential holder, purpose for UE to access NPN, onboarding request, request for performing access using a credential obtained from a credential holder, identification of a target NPN and/or desired NPN, group identifications for network selection and/or list of group identifications for network selection corresponding to a network accessed by UE, and cause why NPN access requirement information of a UE cannot be reported.

According to embodiments of the present disclosure, the sixth information includes one or more of the following: transmitting node identification, receiving node identification, NPN support capability information of neighboring cells and/or neighboring nodes, supported NPN identification, extra onboarding support identification, identification of extra support for performing access using a credential obtained from a credential holder, group identifications for network selection corresponding to extra support, and trigger event.

According to embodiments of the present disclosure, the ninth information includes one or more of the following: transmitting node identification, receiving node identification, NPN identification corresponding to reported information, reporting content and trigger event.

According to embodiments of the present disclosure, the twelfth information includes one or more of the following: UE identification, node identification, cell identification, NPN identification, time from access to reporting, time from access failure to reporting, time from access attempt to reporting, time from handover to reporting, cause for UE to access NPN, purpose for UE to access and/or register NPN, way for accessing and/or registering NPN, reconnected NPN identification, reconnected cell identification, indication of whether to handover from an NPN to an ordinary cell, indication of whether to handover from an ordinary cell to an NPN, group identifications for network selection, group identifications for network selection of an accessing cell, group identifications for network selection of a neighboring cell, identification of a target NPN and/or desired NPN, network selection mode, cause for access and/or handover failure and/or cause for failure to provide service.

Embodiments of the present disclosure provides a first node device in a wireless communication system, including a transceiver configured to transmit and receive signals; and a processor coupled to the transceiver and configured to perform methods performed by a first node in a wireless communication system according to embodiments of the present disclosure.

Embodiments of the present disclosure provides a second node device in a wireless communication system, including a transceiver configured to transmit and receive signals; and a processor coupled to the transceiver and configured to perform methods performed by a second node in a wireless communication system according to embodiments of the present disclosure.

Embodiments of the present disclosure provide a computer-readable medium having stored thereon computer-readable instructions which, when executed by a processor, implement methods performed by a first node and/or a second node in a wireless communication system according to embodiments of the present disclosure.

The methods performed by a first node and/or a second node in a wireless communication system provided by the present disclosure enables self-optimization decisions to be made or configuration to be updated at the network side by exchanging information related to the non-public network between nodes.

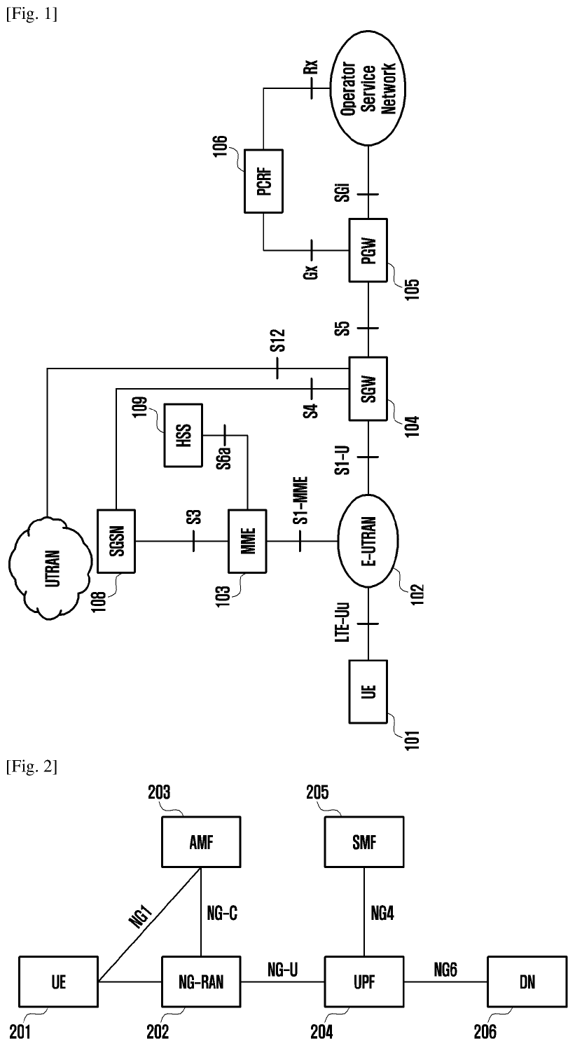

FIGS. 1 to 12B discussed below and various embodiments for describing the principles of the present disclosure in this patent document are only for illustration and should not be interpreted as limiting the scope of the present disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS)109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UEL) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Entities and/or nodes mentioned in the present disclosure may include gNB, gNB Central Unit (gNB-CU), gNB Distributed Unit (gNB-DU), gNB-CU-Control Plane (gNB CU-CP), gNB-CU-User Plane (gNB CU-UP), en-gNB, eNB, ng-eNB, UE, Access and Mobility Management Function (AMF), Session Management Function (SMF), Mobility Management Entity (MME) and other network entities or network logic units.

The signal strength and/or signal quality mentioned in the present disclosure may be a Received Signal Strength Indicator (RSSI), Reference Signal Receiving Power (RSRP), Reference Signal Receiving Quality (RSRQ), Signal to Interference plus Noise Ratio (SINR), etc.

In the existing technology, a node cannot obtain information related to Onboarding support and/or information related to support of performing access using a credential obtained from a CH of neighboring nodes, so that it cannot select a suitable handover target node for the UE to meet requirements of the UE. The existing technology cannot provide NPN related information for network self-optimization, so it cannot optimize issues about NPN related configuration etc.

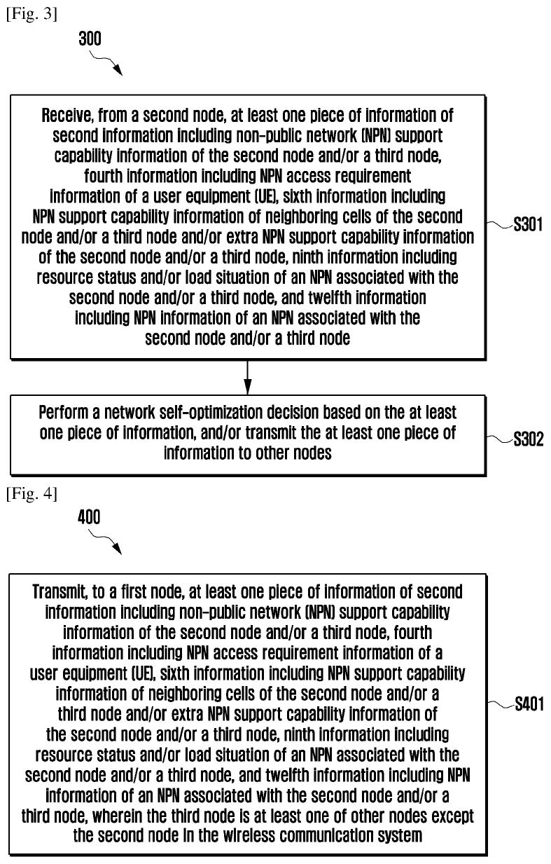

Next, FIG. 3 illustrates a flowchart of a method 300 performed by a first node in a wireless communication system according to embodiments of the present disclosure.

As shown in FIG. 3, in step S301, The method 300 performed by a first node in a wireless communication system according to embodiments of the present disclosure may include: the first node receives, from a second node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, twelfth information including NPN information of an NPN associated with the second node and/or a third node, and fourteenth information including an NPN function activation result of the second node. Additionally or alternatively, the method 300 may include: in step S302, the first node performs a network self-optimization decision based on the at least one piece of information, and/or transmitting the at least one piece of information to other nodes. Herein, the third node may be at least one of any other nodes except the second node in the wireless communication system, information associated with which can be obtained by the second node by any means. In addition, the first node, the second node, the third node and other nodes mentioned herein may be any of the example nodes listed above or a node newly introduced in the future, and there is no restriction herein. In some implementations, the at least one piece of information may be determined by the second node itself or may be received by the second node from other nodes. In some implementations, the second node may or may not perform network self-optimization based on the at least one piece of information.

Additionally or alternatively, the method 300 may further include: before receiving the at least one piece of information from the second node, the first node transmits first information including a request for non-public network (NPN) support capability information of the second node and/or a third node to the second node. In some implementations, the second information described above may be transmitted by the second node to the first node autonomously or based on the first information.

Additionally or alternatively, the method 300 may further include: before receiving the at least one piece of information from the second node, the first node transmits third information including a request for the NPN access requirement information of a user equipment (UE) to the second node. In some implementations, the fourth information described above may be transmitted by the second node to the first node autonomously or based on the third information.

Additionally or alternatively, the method 300 may further include: before receiving the at least one piece of information from the second node, the first node transmits fifth information including a request for the NPN support capability information of neighboring cells of the second node and/or a third node and/or extra NPN support capability information of the second node and/or a third node to the second node. In some implementations, the sixth information described above may be transmitted by the second node to the first node autonomously or based on the fifth information. The “extra NPN support capability” of a specific node mentioned herein may refer to a capability that the specific node can provide NPN support function by other means besides directly utilizing its own NPN support capability, for example, providing NPN support function by utilizing an other node other than the specific node or NPN support capability of the other node, which will be described in detail in combination with specific example fields.

Additionally or alternatively, the method 300 may further include: before receiving the at least one piece of information from the second node, the first node transmits seventh information including a request for the resource status and/or load situation of an NPN associated with the second node and/or a third node to the second node, and the first node receives eighth information including a response to the request for the resource status and/or load situation of an NPN associated with the second node and/or a third node from the second node. In some implementations, the ninth information described above may be transmitted by the second node to the first node autonomously or based on the seventh information.

Additionally or alternatively, the method 300 may further include: before receiving the at least one piece of information from the second node, the first node transmits eleventh information including a request for the NPN information of an NPN associated with the second node and/or a third node to the second node. In some implementations, the twelfth information described above may be transmitted by the second node to the first node autonomously or based on the eleventh information.

Additionally or alternatively, the method 300 may further include: before transmitting eleventh information including a request for the NPN information of an NPN associated with the second node and/or a third node to the second node, the first node receives tenth information used for indicating that the NPN information of an NPN associated with the second node and/or a third node is available from the second node. In some implementations, the eleventh information described above may be transmitted by the first node to the second node autonomously or based on the tenth information. Herein, an NPN associated with a specific node may refer to an NPN that can be accessed through the specific node or an NPN of which the specific node forms a part, or an NPN whose NPN information can be obtained by the specific node in any way.

FIG. 4 illustrates a flowchart of a method 400 performed by a second node in a wireless communication system according to embodiments of the present disclosure.

As shown in FIG. 4, in step S401, The method 400 performed by a first node in a wireless communication system according to embodiments of the present disclosure may include: the second node transmits, to a first node, at least one piece of information of second information including non-public network (NPN) support capability information of the second node and/or a third node, fourth information including NPN access requirement information of a user equipment (UE), sixth information including NPN support capability information of neighboring cells of the second node and/or a third node and/or extra NPN support capability information of the second node and/or a third node, ninth information including resource status and/or load situation of an NPN associated with the second node and/or a third node, twelfth information including NPN information of an NPN associated with the second node and/or a third node, and fourteenth information including an NPN function activation result of the second node. Herein, the third node may be at least one of any other nodes except the second node in the wireless communication system, information associated with which can be obtained by the second node by any means. In addition, the first node, the second node, the third node and other nodes mentioned herein may be any of the example nodes listed above or a node newly introduced in the future, and there is no restriction herein. In some implementations, the at least one piece of information may be determined by the second node itself or may be received by the second node from other nodes. In some implementations, the second node may or may not perform network self-optimization based on the at least one piece of information.

Additionally or alternatively, the method 400 may further include: before transmitting the at least one piece of information to the first node, the second node receives first information including a request for non-public network (NPN) support capability information of the second node and/or a third node from the first node. In some implementations, the second information described above may be transmitted by the second node to the first node autonomously or based on the first information.

Additionally or alternatively, the method 400 may further include: before transmitting the at least one piece of information to the first node, the second node receives third information including a request for the NPN access requirement information of a user equipment (UE) from the first node. In some implementations, the fourth information described above may be transmitted by the second node to the first node autonomously or based on the third information.

Additionally or alternatively, the method 400 may further include: before transmitting the at least one piece of information to the first node, the second node receives fifth information including a request for the NPN support capability information of neighboring cells of the second node and/or a third node and/or extra NPN support capability information of the second node and/or a third node from the first node. In some implementations, the sixth information described above may be transmitted by the second node to the first node autonomously or based on the fifth information. The “extra NPN support capability” of a specific node mentioned herein may refer to a capability that the specific node can provide NPN support function by other means besides directly utilizing its own NPN support capability, for example, providing NPN support function by utilizing an other node other than the specific node or NPN support capability of the other node, which will be described in detail in combination with specific example fields.

Additionally or alternatively, the method 400 may further include: before transmitting the at least one piece of information to the first node, the second node receives seventh information including a request for the resource status and/or load situation of an NPN associated with the second node and/or a third node from the first node, and the second node transmits eighth information including a response to the request for the resource status and/or load situation of an NPN associated with the second node and/or a third node to the first node. In some implementations, the ninth information described above may be transmitted by the second node to the first node autonomously or based on the seventh information.

Additionally or alternatively, the method 400 may further include: before transmitting the at least one piece of information to the first node, the second node receives eleventh information including a request for the NPN information of an NPN associated with the second node and/or a third node from the first node. In some implementations, the twelfth information described above may be transmitted by the second node to the first node autonomously or based on the eleventh information.

Additionally or alternatively, the method 400 may further include: before receiving eleventh information including a request for the NPN information of an NPN associated with the second node and/or a third node from the first node, the second node transmits tenth information used for indicating that the NPN information of an NPN associated with the second node and/or a third node is available to the first node. In some implementations, the eleventh information described above may be transmitted by the first node to the second node autonomously or based on the tenth information. Herein, an NPN associated with a specific node may refer to an NPN that can be accessed through the specific node or an NPN of which the specific node forms a part, or an NPN whose NPN information can be obtained by the specific node in any way.

Steps or operations included in the method 300 and the method 400 according to embodiments of the present disclosure as described above may be performed individually or jointly in any combination, and may be performed in any order, for example, simultaneously or in a reverse order of the listed order. In addition, various steps or operations and various information described above will be further described below with specific examples.

The methods performed by a first node and/or a second node in a wireless communication system according to embodiments of the present disclosure will be further described from various aspects with specific examples. More generally, a method performed by a first node and/or a second node in a wireless communication system according to embodiments of the present disclosure may also be called a method for supporting non-public network self-optimization.

### Example 1

An example of the present disclosure proposes a method for supporting non-public network self-optimization, which may include: a first node transmits first information including a request for NPN support capability information to a second node to request the second node to report NPN support capability information, so that the first node can request and obtain the NPN support capability information of the second node (and/or a third node), and the first node can perform a self-optimization decision and/or update related configurations based on the obtained NPN support capability information, etc., so as to improve network performance, such as ensuring the performance for a user after handover.

In some implementations, the first information may be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the first information may include one or more of the following fields or related information:
Transmitting node identification: an identification of a node that transmits the first information.
Receiving node identification: an identification of a node that receives the first information.
NPN identification corresponding to requested information: used to identify the NPN corresponding to the requested information. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Content requested for reporting: used to identify the content and/or content list that needs to be reported. It may include one or more of the following: Onboarding support identification, identification about that access can be performed using a credential obtained from a CH, Group IDs for Network selection (GINs), capability of Onboarding support, capability of that access can be performed using a credential obtained from a CH, whether Onboarding support is enabled, whether that access can be performed using a credential obtained from a CH is enabled, etc. In an implementation, the Onboarding support identification is used to indicate whether the NPN supports Onboarding; the identification about that access can be performed using a credential obtained from a CH is used to indicate whether the NPN supports access using a credential obtained from a CH; the capability of Onboarding support indicates whether the NPN has a capability to support onboarding; the capability of that access can be performed using a credential obtained from a CH indicates whether the NPN has a capability of that access can be performed using a credential obtained from a CH; whether Onboarding support is enabled indicates whether the NPN has enabled the support function if it has a capability of Onboarding support; whether that access can be performed using a credential obtained from a CH is enabled indicates whether the NPN has enabled the support function if it has a capability of that access can be performed using a credential obtained from a CH.
Reporting type: used to indicate the type of reporting, for example, it may include On-demand, single reporting, periodic reporting, event-triggered, etc.
Reporting registration request: used to indicate the start, end, addition, etc. of a reporting.
Reporting interval: used to indicate the reporting time interval of a periodic reporting.
Trigger event: used to indicate an event that can trigger reporting. When the trigger event is met, reporting will be performed. For example, it may be a change of NPN support capability information.

In some implementations, the second node may transmit second information including NPN support capability information to the first node according to its own situation and/or according to the received first information including a request for the NPN support capability information, so that the first node can obtain the NPN support capability information of the second node (and/or a third node), and the first node can perform a self-optimization decision and/or update related configurations based on the obtained NPN support capability information, etc., so as to improve network performance, such as ensuring the performance for a user after handover. In some implementations, when the first node makes a handover decision for a UE, it selects a node of an NPN that can support access by the UE as a handover target node.

In some implementations, the second information may be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the second information may include one or more of the following fields or related information:
Transmitting node identification: an identification of a node that transmits the second information.
Receiving node identification: an identification of a node that receives the second information.
NPN identification: used to identify the NPN corresponding to the second information. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Onboarding support identification: used to indicate whether an NPN supports Onboarding and whether an Onboarding NPN allows registration for a purpose of Onboarding in a cell. This field may be represented by a single bit. For example, when the bit is 1, it means that the NPN supports Onboarding, and when the bit is 0, it means that the NPN does not support Onboarding; alternatively, when the bit is 0, it means that the NPN supports Onboarding, and when the bit is 1, it means that the NPN does not support Onboarding.
Identification about that access can be performed using a credential obtained from a CH: used to indicate whether an NPN supports access using a credential obtained from a CH. This field may be represented by a single bit. For example, when the bit is 1, it means that the NPN supports access using a credential obtained from a CH, and when the bit is 0, it means that the NPN does not support access using a credential obtained from a CH; alternatively, when the bit is 0, it means that the NPN supports access using a credential obtained from a CH, and when the bit is 1, it means that the NPN does not support access using a credential obtained from a CH.
Group IDs for Network selection (GINs): used to indicate GINs and/or a list of GINs corresponding to Onboarding access and/or access using a credential obtained from a CH.
(Indication of) capability of Onboarding support: used to indicate whether the NPN has a capability to support onboarding and whether it allows a capability of registration for a purpose of onboarding in a cell. This field may be represented by a single bit. For example, when the bit is 1, it means that the NPN has a capability to support onboarding, and when the bit is 0, it means that the NPN does not have a capability to support onboarding; alternatively, when the bit is 0, it means that the NPN has a capability to support onboarding, and when the bit is 1, it means that the NPN does not have a capability to support onboarding.
(Indication of) capability of that access can be performed using a credential obtained from a CH: used to indicate whether the NPN has a capability of that access can be performed using a credential obtained from a CH. This field may be represented by a single bit. For example, when the bit is 1, it means that the NPN has a capability of that access can be performed using a credential obtained from a CH, and when the bit is 0, it means that the NPN does not have a capability of that access can be performed using a credential obtained from a CH; alternatively, when the bit is 0, it means that the NPN has a capability of that access can be performed using a credential obtained from a CH, and when the bit is 1, it means that the NPN does not have a capability of that access can be performed using a credential obtained from a CH.
(Indication of) whether Onboarding support is enabled: used to indicate whether the NPN has enabled the support function if it has a capability of Onboarding support. This field may be represented by a single bit. For example, when the bit is 1, it means that the NPN has enabled the support function, and when the bit is 0, it means that the NPN has not enabled the support function; alternatively, when the bit is 0, it means that the NPN has enabled the support function, and when the bit is 1, it means that the NPN has not enabled the support function. In an implementation, if the load of the cell or the node is too heavy, the NPN can disable the onboarding support function to ensure service requirements of users accessing to the NPN or users who need to access the NPN to obtain service of this NPN. In another implementation, if the cell or the node wants to reduce energy consumption and achieve a goal of energy saving, the onboarding support function can be disabled.
(Indication of) whether that access can be performed using a credential obtained from a CH is enabled: used to indicate whether the NPN has enabled the support function if it has a capability of that access can be performed using a credential obtained from a CH. This field may be represented by a single bit. For example, when the bit is 1, it means that the NPN has enabled the support function, and when the bit is 0, it means that the NPN has not enabled the support function; alternatively, when the bit is 0, it means that the NPN has enabled the support function, and when the bit is 1, it means that the NPN has not enabled the support function. In an implementation, if the load of the cell or the node is too heavy, the NPN can disable the support function to ensure service requirements of users accessing to the NPN or users who need to access the NPN to obtain service of this NPN. In another implementation, if the cell or the node wants to reduce energy consumption and achieve a goal of energy saving, the support function can be disabled.
Trigger event: used to indicate an event that triggered the reporting, for example, it may be a change of NPN support capability information.
Cause for failure to report: used to indicate the reason why NPN support capability information cannot be reported. It may include one or more of the following: there is no NPN support capability information, there is no NPN information, NPN is not supported, SNPN is not supported, PNI-NPN is not supported, etc.

### Example 2

An example of the present disclosure proposes a method for supporting non-public network self-optimization, which may include: a first node transmits third information including a request for UE-related NPN access requirement information (for example, a request for NPN access requirement information of a specific UE) to a second node to request the second node to report the UE-related NPN access requirement information, for the first node to request so as to obtain the UE-related NPN access requirement information (for example, NPN access requirement information of the specific UE), and the first node can perform a self-optimization decision and/or update related configurations based on the obtained UE-related NPN access requirement information, so as to improve network performance, such as ensuring the performance for a user after handover.

In some implementations, the third information may be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or a HANDOVER REQUEST ACKNOWLEDGE message, a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the third information may include one or more of the following fields or related information:
Transmitting node identification: an identification of a node that transmits the third information.
Receiving node identification: an identification of a node that receives the third information.
UE identification: identifying a UE to which the requested NPN access requirement information belongs.
Reporting registration request: used to indicate the start, end, addition, etc. of a reporting.
NPN access requirement content requested to be reported:
   NPN identification: used to indicate an identification corresponding to an NPN accessed by the UE. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
   Reason and/or access reason and/or registration reason: indicating a reason for a UE to access and/or register an NPN, or a reason for handover and/or a requirement for handover, or a reason for adding nodes and/or modifying nodes and/or releasing nodes, or a reason for adding secondary nodes and/or modifying secondary nodes and/or releasing secondary nodes, or a reason for mobility decision, etc. It may include one or more of the following: Onboarding, access using a credential obtained from a CH, normal access, etc.
   Whether to need and/or support onboarding
   Whether to need and/or support access using a credential obtained from a CH
   Access purpose: indicating the purpose for a UE to access an NPN. It may include one or more of the following: Onboarding, access using a credential obtained from a CH, normal access, etc.
   Identification of a target NPN and/or desired NPN: indicating an identification of an NPN network that a UE actually wants to access. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
   GIN(s) corresponding to access: used to indicate the GIN(s) and/or a list of GIN(s) corresponding to a network accessed by the UE.
   Requirement for Onboarding: indicating whether the UE requests to access and/or register an NPN for the purpose of Onboarding. This field may be represented by a single bit. For example, when the bit is 1, it means that access to NPN is requested for the purpose of Onboarding; and when the bit is 0, it means that access to NPN is not requested for the purpose of Onboarding; alternatively, when the bit is 0, it means that access to NPN is requested for the purpose of Onboarding; and when the bit is 1, it means that access to NPN is not requested for the purpose of Onboarding.
   Requirement for performing access using a credential obtained from a CH: indicating whether the UE requests to perform access using a credential obtained from a CH. This field may be represented by a single bit. For example, when the bit is 1, it means that access using a credential obtained from a CH is requested, and when the bit is 0, it means that access using a credential obtained from a CH is not requested; alternatively, when the bit is 0, it means that access using a credential obtained from a CH is requested, and when the bit is 1, it means that access using a credential obtained from a CH is not requested.

In some implementations, the second node may transmit fourth information including UE-related NPN access requirement information to the first node according to its own situation (autonomously) and/or according to the received request for NPN access requirement information, so that the first node can obtain the UE-related NPN access requirement information, and the first node can perform a self-optimization decision and/or update related configurations based on the obtained UE-related NPN access requirement information, so as to improve network performance, such as ensuring the performance for a user after handover. In some implementations, when a first node makes a handover request for a UE, it may carry (e.g., transmit to a target node) NPN access requirement information (e.g., the NPN access requirement information of the UE), and the target node accepts and/or rejects the handover request according to the NPN access requirement information. For example, it may be that when the target node can support the NPN access requirement, it accepts the handover request; and when the target node cannot support the NPN access requirement, it rejects the handover request. It should be understood that the UE-related NPN access requirement information described herein may be the NPN access requirement information of any UE that can be obtained by the second node and/or the third node.

In some implementations, the fourth information may be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; a HANDOVER REQUEST message or a RETRIEVE UE CONTEXT RESPONSE message or a RETRIEVE UE CONTEXT FAILURE message of X2 or Xn; or a SENB ADDITION REQUEST message or a SGNB ADDITION REQUEST of X2; or an S-NODE ADDITION REQUEST message of Xn; or a BEARER CONTEXT SETUP REQUEST message of E1; or an other and/or newly defined RRC and/or Xn and/or X2 and/or F1 and/or E1 and/or NG message.

In some implementations, the fourth information may include one or more of the following fields or related information:
Transmitting node identification: an identification of a node that transmits the fourth information.
Receiving node identification: an identification of a node that receives the fourth information.
UE identification: identifying a UE to which the requested NPN access requirement information belongs.
NPN identification: used to indicate an identification corresponding to an NPN that the UE needs to access. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Reason and/or access reason and/or registration reason: indicating a reason for a UE to access and/or register an NPN, or a reason for handover and/or a requirement for handover, or a reason for adding nodes and/or modifying nodes and/or releasing nodes, or a reason for adding secondary nodes and/or modifying secondary nodes and/or releasing secondary nodes, or a reason for mobility decision, etc. It may include one or more of the following: Onboarding, access using a credential obtained from a CH, normal access, etc.
Whether to need and/or support onboarding
Whether to need and/or support access using a credential obtained from a CH
Access purpose: indicating the purpose for a UE to access an NPN. It may include one or more of the following: Onboarding, access using a credential obtained from a CH, normal access, etc.
Onboarding request: indicating that the UE requests to access and/or register an NPN for the purpose of Onboarding. This field may be represented by a single bit. For example, when the bit is 1, it means that access to NPN is requested for the purpose of Onboarding; and when the bit is 0, it means that access to NPN is not requested for the purpose of Onboarding; alternatively, when the bit is 0, it means that access to NPN is requested for the purpose of Onboarding; and when the bit is 1, it means that access to NPN is not requested for the purpose of Onboarding.
Request for performing access using a credential obtained from a CH: it means that the UE requests to perform access using a credential obtained from a CH. This field may be represented by a single bit. For example, when the bit is 1, it means that access using a credential obtained from a CH is requested, and when the bit is 0, it means that access using a credential obtained from a CH is not requested; alternatively, when the bit is 0, it means that access using a credential obtained from a CH is requested, and when the bit is 1, it means that access using a credential obtained from a CH is not requested.
Identification of a target NPN and/or desired NPN: indicating an identification of an NPN network that a UE actually wants to access. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
GIN(s) corresponding to access: used to indicate the GIN(s) and/or a list of GIN(s) corresponding to a network accessed by the UE.
Cause for failure to report: used to indicate the reason why NPN access requirement information of a UE cannot be reported. It may include one or more of the following: there is no UE-related NPN access requirement information, the UE does not support NPN access, the UE does not support SNPN access, and the UE does not support PNI-NPN access, etc.

### Example 3

An example of the present disclosure proposes a method for supporting non-public network self-optimization, which may include: a first node transmits fifth information including a request for NPN support capability information of neighboring cells and/or extra NPN support capability information to a second node to request the second node to report the NPN support capability information of neighboring cells and/or extra NPN support capability information, so that the first node can request and obtain the NPN support capability information of neighboring cells and/or extra NPN support capability information, and the first node can perform network selection according to the received NPN support capability information of neighboring cells and/or extra NPN support capability information, so as to reduce network selection errors, and reduce the case that the selected network cannot meet requirements. The support capability information of a neighboring cell described herein may be the neighboring cell NPN support capability information of the second node and/or a third node, and the extra NPN support capability information may be the extra NPN support capability information of the second node and/or a third node.

In some implementations, the fifth information may be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the fifth information may include one or more of the following fields or related information:
Transmitting node identification: an identification of a node that transmits the fifth information.
Receiving node identification: an identification of a node that receives the fifth information.
NPN support capability information of neighboring cells and/or neighboring nodes requested to be reported:
   Neighboring cell identification: an identification of a neighboring cell.
   Neighboring node identification: an identification of a neighboring node.
   Supported NPN identification: used to identify an identification and/or a list of identifications of NPNs supported by a neighboring cell and/or a neighboring node. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
   Onboarding support identification: used to indicate whether an NPN supports Onboarding and whether an Onboarding NPN allows registration for a purpose of Onboarding in a cell.
   Identification about that access can be performed using a credential obtained from a CH: used to indicate whether an NPN supports access using a credential obtained from a CH.
   Group IDs for Network selection (GINs): used to indicate GINs and/or a list of GINs corresponding to Onboarding access and/or access using a credential obtained from a CH.
NPN identification corresponding to information requested to be reported: used to identify an identification and/or a list of identifications of NPNs corresponding to the information requested to be reported. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
Extra NPN support capability information requested to be reported:
   Extra onboarding support identification: an identification used to indicate whether the node can provide onboarding support in other ways. The other ways may be to select other nodes to support an Onboarding function. In some implementations, for example, an other node that supports onboarding may be selected as a node in dual-connectivity (for example, it may be a master node and/or a secondary node, etc.) to form a dual-connectivity, thereby providing onboarding support. In some implementations, for example, the node can be accessed first, and then handover from the node to an other node that supports onboarding can be performed, thereby providing onboarding support, and so on.
   Identification of extra support for performing access using a credential obtained from a CH: used to indicate whether the node can provide a support of performing access using a credential obtained from a CH in other ways. The other ways may be to select other nodes to support access using a credential obtained from a CH. In some implementations, for example, an other node that supports access using a credential obtained from a CH may be selected as a node in dual-connectivity (for example, it may be a master node and/or a secondary node, etc.) to form a dual-connectivity, thus providing support for access using a credential obtained from a CH. In some implementations, for example, the node can be accessed first, and then handover from the node to an other node that supports access using a credential obtained from a CH can be performed, thus providing support for access using a credential obtained from a CH, and so on.
   Group IDs for Network Selection (GINs) corresponding to extra support: used to indicate GINs and/or a list of GINs corresponding to Onboarding access and/or access using a credential obtained from a CH when extra support is provided. The extra support may be whether the node can support onboarding access and/or access using a credential obtained from a CH in other ways. For example, the other ways may be to select an other node as a node in dual-connectivity (for example, it may be a master node and/or a secondary node, etc.) to form a dual-connectivity, thereby providing support for onboarding access and/or access using a credential obtained from a CH. In some implementations, for example, the node may be accessed first, and then handover from the node to an other node that supports onboarding access and/or access using a credential obtained from a CH may be performed, thereby providing support for onboarding access and/or access using a credential obtained from a CH, and so on.
Reporting type: used to indicate the type of reporting, for example, it may include On-demand, single reporting, periodic reporting, event-triggered, etc.
Reporting registration request: used to indicate the start, end, addition, etc. of a reporting.
Reporting interval: used to indicate the reporting time interval of a periodic reporting.
Trigger event: used to indicate an event that can trigger reporting. When the trigger event is met, reporting will be performed. For example, it may be a change of NPN support capability information of neighboring cells and/or a change of extra NPN support capability information.

In some implementations, the second node may transmit and/or broadcast sixth information including NPN support capability information of neighboring cells and/or the extra NPN support capability information (for example, of the second node and/or a third node) to the first node according to its own situation (autonomously) and/or based on the received request for NPN support capability information of neighboring cells and/or extra NPN support capability information, so that the first node can obtain the NPN support capability information of neighboring cells and/or extra NPN support capability information, and the first node can perform network selection according to the received NPN support capability information of neighboring cells and/or extra NPN support capability information, so as to reduce network selection errors, and reduce the case that the selected network cannot meet requirements. In some implementations, the base station broadcasts NPN support capability information to the UE, and after receiving the broadcast information, the UE selects a cell that can support the related NPN access requirement of the UE for access.

In some implementations, the sixth information may be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the sixth information may include one or more of the following fields or related information:
Transmitting node identification: an identification of a node that transmits the sixth information.
Receiving node identification: an identification of a node that receives the sixth information.
NPN support capability information of neighboring cells and/or neighboring nodes:
   Neighboring cell identification: an identification of a neighboring cell.
   Neighboring node identification: an identification of a neighboring node.
   Supported NPN identification: used to identify an identification and/or a list of identifications of NPNs supported by a neighboring cell and/or a neighboring node. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
   Onboarding support identification: used to indicate whether an NPN supports Onboarding and whether an Onboarding NPN allows registration for a purpose of Onboarding in a cell. This field may be represented by a single bit. For example, when the bit is 1, it means that the NPN supports Onboarding, and when the bit is 0, it means that the NPN does not support Onboarding; alternatively, when the bit is 0, it means that the NPN supports Onboarding, and when the bit is 1, it means that the NPN does not support Onboarding.
   Identification about that access can be performed using a credential obtained from a CH: used to indicate whether an NPN supports access using a credential obtained from a CH. This field may be represented by a single bit. For example, when the bit is 1, it means that the NPN supports access using a credential obtained from a CH, and when the bit is 0, it means that the NPN does not support access using a credential obtained from a CH; alternatively, when the bit is 0, it means that the NPN supports access using a credential obtained from a CH, and when the bit is 1, it means that the NPN does not support access using a credential obtained from a CH.
   Group IDs for Network selection (GINs): used to indicate GINs and/or a list of GINs corresponding to Onboarding access and/or access using a credential obtained from a CH.
NPN identification: used to identify the supported NPN identification and/or identification list. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
Extra onboarding support identification: an identification used to indicate whether the node can provide onboarding support in other ways. The other ways may be to select other nodes to support an Onboarding function. In some implementations, for example, an other node that supports onboarding may be selected as a node in dual-connectivity (for example, it may be a master node and/or a secondary node, etc.) to form a dual-connectivity, thereby providing onboarding support. In some implementations, for example, the node can be accessed first, and then handover from the node to an other node that supports onboarding can be performed, thereby providing onboarding support, and so on. This field may be represented by a single bit. For example, when the bit is 1, it means that extra onboarding support can be provided; and when the bit is 0, it means that extra onboarding support cannot be provided; alternatively, when the bit is 0, it means that extra onboarding support can be provided; and when the bit is 1, it means that extra onboarding support cannot be provided.
Identification of extra support for performing access using a credential obtained from a CH: used to indicate whether the node can provide a support of performing access using a credential obtained from a CH in other ways. The other ways may be to select other nodes to support access using a credential obtained from a CH. In some implementations, for example, an other node that supports access using a credential obtained from a CH may be selected as a node in dual-connectivity (for example, it may be a master node and/or a secondary node, etc.) to form a dual-connectivity, thus providing support for access using a credential obtained from a CH. In some implementations, for example, the node can be accessed first, and then handover from the node to an other node that supports access using a credential obtained from a CH can be performed, thus providing support for access using a credential obtained from a CH, and so on. This field may be represented by a single bit. For example, when the bit is 1, it means that extra support for performing access using a credential obtained from a CH can be provided; and when the bit is 0, it means that extra support for performing access using a credential obtained from a CH cannot be provided; alternatively, when the bit is 0, it means that extra support for performing access using a credential obtained from a CH can be provided; and when the bit is 1, it means that extra support for performing access using a credential obtained from a CH cannot be provided.
Group IDs for Network Selection (GINs) corresponding to extra support: used to indicate GINs and/or a list of GINs corresponding to Onboarding access and/or access using a credential obtained from a CH when extra support is provided. The extra support may be whether the node can support onboarding access and/or access using a credential obtained from a CH in other ways. For example, the other ways may be to select an other node as a node in dual-connectivity (for example, it may be a master node and/or a secondary node, etc.) to form a dual-connectivity, thereby providing support for onboarding access and/or access using a credential obtained from a CH. In some implementations, for example, the node may be accessed first, and then handover from the node to an other node that supports onboarding access and/or access using a credential obtained from a CH may be performed, thereby providing support for onboarding access and/or access using a credential obtained from a CH, and so on.
Trigger event: used to indicate an event that triggered the reporting, for example, it may be a change of NPN support capability information of a neighboring cell and/or a change of extra NPN support capability information.

By exchanging extra NPN support information between nodes, the following problems can be avoided, such as radio link failure, for example, due to the mobility of the UE, the quality of the radio link deteriorates but the nodes cannot perform handover or other operations for the UE when all the neighboring cells cannot support an NPN that the UE needs to access, leading to radio link failure. Based on the extra NPN support information exchanged between nodes, the node can handover the UE to a cell (for example, cell A) and/or node that can provide the required service for accessing to an NPN indirectly, and after the UE hands over to cell A, the node on which cell A is located will add the cell and/or node that supports the NPN that the UE requires to access as the secondary node of the UE, so that the UE can access the NPN that is required to access. Or it may be that the node on which cell A is located performs subsequent handover for the UE, to handover to a cell that supports the NPN that the UE requires to access, so that the UE can access the NPN that is required to access.

### Example 4

An example of the present disclosure proposes a method for supporting non-public network self-optimization, which may include: a first node transmits seventh information including a request for resource status and/or load situation of an NPN to a second node, to request the second node to report information of the resource status and/or load situation of the NPN to the first node, so as to initiate requested measurements, so that the first node can obtain the resource status and/or load situation of an NPN of the second node and/or other nodes, so as to provide reference information for the first node to perform a self-optimization decision. In some implementations, the request for resource status and/or load situation of an NPN may be a request for resource status and/or load situation of an NPN associated with the second node and/or a third node other than the second node.

The seventh information may be included in one or more of the following: a RESOURCE STATUS REQUEST message of X2 or Xn or F1 or E1; or an EN-DC RESOURCE STATUS REQUEST message of X2; or an other and/or newly defined RRC and/or Xn and/or X2 and/or F1 and/or E1 and/or NG message.

In some implementations, the seventh information may include one or more of the following fields or related information:
Transmitting node identification: an identification of a node that transmits the seventh information.
Receiving node identification: an identification of a node that receives the seventh information.
NPN identification: used to indicate an identification and/or a list of identifications of NPNs corresponding to the requested information. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
Requested content: used to indicate parameters that need to be reported and/or measurement objects that need to be reported. This field may also be named Report Characteristics. The report parameters and/or measurement objects include one or more of the following of NPN: resource status and/or load information, Transport Network Layer (TNL) capacity indicator, radio resource status, composite available capacity group, composite available resource group, number of active UEs, number of Radio Resource Control (RRC) connections, slice available capacity, hardware capacity indicator, S1 TNL load indicator, hardware (HW) load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, percentage of access for onboarding purpose, percentage of access using a credential obtained from a CH, Energy Consumption, Energy Efficiency, and jitter of each content parameter, whether the load is too high, whether the load is too low, indication that each and/or overall of the above parameters are too high, indication that each and/or overall of the above parameters are too low, assessment values of the above parameters, NPN specific resource situation, and so on. Herein the jitter may be a variance or standard deviation of a parameter. The above parameters may be one's own instances, or instances of a neighboring cell, or instances of other coexistence technologies (for example, WLAN, Bluetooth, etc.), or a sum of one's own instance and an instance of a neighboring cell, or an average of one's own instance and an instance of a neighboring cell. The above parameters may be instances for uplink, or instances for downlink, or instances for uplink and downlink. The requested content may be an actual value or a predicted value. Herein, whether the load is too high and/or whether the load is too low may be an assessment of the overall instances or an individual assessment of an above parameter. The above parameters may also be the load situation and/or resource status of one or more NPNs, or the load situation and/or resource status of one or more NPNs that support access for the purpose of onboarding, or the load situation and/or resource status of one or more NPNs that support access using a credential obtained from a CH. This field may be expressed in the form of a bitmap, and each position of the bitmap corresponds to a measurement object, and when the bit indicates that reporting is needed, it means that the corresponding measurement object needs to be reported. The NPN specific resource situation includes one or more of the following: the resource situation occupied for supporting onboarding, resource situation for supporting access using a credential obtained from a CH, percentage of resources for supporting onboarding, percentage of resources for supporting access using a credential obtained from a CH, etc. Herein, the resource and/or resource situation may be one or more of the above parameters.
Reporting type: used to indicate the type of reporting, for example, it may include On-demand, single reporting, periodic reporting, event-triggered, etc.
Reporting registration request: used to indicate the start, end, addition, etc. of a reporting.
Reporting interval: used to indicate the reporting time interval of a periodic reporting.

Trigger event: used to indicate an event that can trigger reporting. When the trigger event is met, reporting will be performed. For example, it may include one or more of the following: the change of NPN's resource status and/or load situation is greater than and/or greater than or equal to a certain threshold, the load is too large, the load is too small, the predicted change of NPN's resource status and/or load situation is greater than and/or greater than or equal to a certain threshold, the predicted load is too large, and the predicted load is too small.

In some implementations, the second node may transmit eighth information including a response to the request for the resource status and/or load situation of an NPN to the first node according to the request, so as to feed back to the first node whether reporting can be performed, for example, all and/or part of the measurement objects can be successfully initiated, and/or all and/or part of the measurement objects cannot be initiated.

In some implementations, the eighth information may be included in one or more of the following: a RESOURCE STATUS RESPONSE message or a RESOURCE STATUS FAILURE message of X2 or Xn or F1 or E1; or an EN-DC RESOURCE STATUS RESPONSE message or an EN-DC RESOURCE STATUS FAILURE message of X2; or an other and/or newly defined RRC and/or Xn and/or X2 and/or F1 and/or E1 and/or NG message.

In some implementations, the eighth information may include one or more of the following fields or related information:
Transmitting node identification: an identification of a node that transmits the eighth information.
Receiving node identification: an identification of a node that receives the eighth information.
NPN identification corresponding to the information that can be reported: indicating NPN identification and/or identification list corresponding to resource status and/or load situation that can be reported. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
The content that can be reported: indicating content and/or content list and/or measurement object and/or measurement object list that can be reported, and it may include one or more of the following of NPN: resource status and/or load information, Transport Network Layer (TNL) capacity indicator, radio resource status, composite available capacity group, composite available resource group, number of active UEs, number of Radio Resource Control (RRC) connections, slice available capacity, hardware capacity indicator, S1 TNL load indicator, hardware load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, percentage of access for onboarding purpose, percentage of access using a credential obtained from a CH, Energy Consumption, Energy Efficiency, and jitter of each content parameter, whether the load is too high, whether the load is too low, indication that each and/or overall of the above parameters are too high, indication that each and/or overall of the above parameters are too low, assessment values of the above parameters, NPN specific resource situation, and so on. Herein the jitter may be a variance or standard deviation of a parameter. The above parameters may be one's own instances, or instances of a neighboring cell, or instances of other coexistence technologies (for example, WLAN, Bluetooth, etc.), or a sum of one's own instance and an instance of a neighboring cell, or an average of one's own instance and an instance of a neighboring cell. The above parameters may be instances for uplink, or instances for downlink, or instances for uplink and downlink. The content that can be reported may be an actual value or a predicted value. Herein, whether the load is too high and/or whether the load is too low may be an assessment of the overall instances or an individual assessment of an above parameter. The above parameters may also be the load situation and/or resource status of one or more NPNs, or the load situation and/or resource status of one or more NPNs that support access for the purpose of onboarding, or the load situation and/or resource status of one or more NPNs that support access using a credential obtained from a CH. This field may be expressed in the form of a bitmap, and each position of the bitmap corresponds to a measurement object, and when the bit indicates that reporting can be performed, it means that the corresponding measurement object can be reported. The NPN specific resource situation includes one or more of the following: the resource situation occupied for supporting onboarding, resource situation for supporting access using a credential obtained from a CH, percentage of resources for supporting onboarding, percentage of resources for supporting access using a credential obtained from a CH, etc. Herein, the resource and/or resource situation may be one or more of the above parameters.
NPN identification corresponding to the information that can not be reported: indicating NPN identification and/or identification list corresponding to resource status and/or load situation that can not be reported. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
The content that can not be reported: indicating the content and/or list and/or measurement object and/or measurement object list that cannot be reported, and it may include one or more of the following of NPN: resource status and/or load information, Transport Network Layer (TNL) capacity indicator, radio resource status, composite available capacity group, composite available resource group, number of active UEs, number of Radio Resource Control (RRC) connections, slice available capacity, hardware capacity indicator, S1 TNL load indicator, hardware load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, percentage of access for onboarding purpose, percentage of access using a credential obtained from a CH, Energy Consumption, Energy Efficiency, and jitter of each content parameter, whether the load is too high, whether the load is too low, indication that each and/or overall of the above parameters are too high, indication that each and/or overall of the above parameters are too low, assessment values of the above parameters, NPN specific resource situation, and so on. Herein the jitter may be a variance or standard deviation of a parameter. The above parameters may be one's own instances, or instances of a neighboring cell, or instances of other coexistence technologies (for example, WLAN, Bluetooth, etc.), or a sum of one's own instance and an instance of a neighboring cell, or an average of one's own instance and an instance of a neighboring cell. The above parameters may be instances for uplink, or instances for downlink, or instances for uplink and downlink. The content that can not be reported may be an actual value or a predicted value. Herein, whether the load is too high and/or whether the load is too low may be an assessment of the overall instances or an individual assessment of an above parameter. The above parameters may also be the load situation and/or resource status of one or more NPNs, or the load situation and/or resource status of one or more NPNs that support access for the purpose of onboarding, or the load situation and/or resource status of one or more NPNs that support access using a credential obtained from a CH. This field may be expressed in the form of a bitmap, and each position of the bitmap corresponds to a measurement object, and when the bit indicates that reporting cannot be performed, it means that the corresponding measurement object cannot be reported. The NPN specific resource situation includes one or more of the following: the resource situation occupied for supporting onboarding, resource situation for supporting access using a credential obtained from a CH, percentage of resources for supporting onboarding, percentage of resources for supporting access using a credential obtained from a CH, etc. Herein, the resource and/or resource situation may be one or more of the above parameters.
Cause: used to indicate the cause for request failure and/or report failure, such as there is no resource state and/or load situation corresponding to an NPN, there is no prediction ability, there is no prediction ability for resource state and/or load situation corresponding to an NPN, etc.

In some implementations, the second node may autonomously transmit ninth information including resource status and/or load situation of an NPN to the first node according to the request for the resource status and/or load situation of the NPN and/or due to the second node's own situation (for example, the resource status and/or load situation of the NPN associated with it is too high or too low), so that the first node can obtain the resource status and/or load situation of an NPN of the second node and/or other nodes, so as to provide reference information for the first node to perform a self-optimization decision, such as applying the actions to reduce high load.

In some implementations, the ninth information may be included in one or more of the following: a RESOURCE STATUS UPDATE message of X2 or Xn or F1 or E1; or an EN-DC RESOURCE STATUS UPDATE message of X2; or a GNB-DU STATUS INDICATION message of F1; or a GNB-CU-UP STATUS INDICATION message of E1; or an other and/or newly defined RRC and/or Xn and/or X2 and/or F1 and/or E1 and/or NG message.

In some implementations, the ninth information may include one or more of the following fields or related information:
Transmitting node identification: an identification of a node that transmits the ninth information.
Receiving node identification: an identification of a node that receives the ninth information.
NPN identification corresponding to reported information: indicating NPN identification and/or identification list corresponding to the reported resource status and/or load situation. The identification may be one or more of the following: Public Land Mobile Network (PLMN) identification, Network Identifier (NID), Closed Access Group (CAG) identification, a combination of PLMN identification and NID, a combination of PLMN identification and CAG identification, etc.
Reporting content: used to indicate parameters of resource status and/or load situation and/or measurement results of measurement objects. The parameters include one or more of the following of NPN: resource status and/or load information, Transport Network Layer (TNL) capacity indicator, radio resource status, composite available capacity group, composite available resource group, number of active UEs, number of Radio Resource Control (RRC) connections, slice available capacity, hardware capacity indicator, S1 TNL load indicator, hardware load indicator, Almost Blank Subframe (ABS) status, Reference Signal Received Power (RSRP) measurement report list, Reference Signal Receiving Quality (RSRQ) measurement report, Signal to Interference plus Noise Ratio (SINR) measurement report, Channel State Information (CSI) report, cell reporting indicator, Channel Occupancy time percentage, Energy Detection threshold, signal strength and/or signal quality, channel busy percentage, percentage of access for onboarding purpose, percentage of access using a credential obtained from a CH, Energy Consumption, Energy Efficiency, and jitter of each content parameter, whether the load is too high, whether the load is too low, indication that each and/or overall of the above parameters are too high, indication that each and/or overall of the above parameters are too low, assessment values of the above parameters, NPN specific resource situation, and so on. Herein the jitter may be a variance or standard deviation of a parameter. The above parameters may be one's own instances, or instances of a neighboring cell, or instances of other coexistence technologies (for example, WLAN, Bluetooth, etc.), or a sum of one's own instance and an instance of a neighboring cell, or an average of one's own instance and an instance of a neighboring cell. The above parameters may be instances for uplink, or instances for downlink, or instances for uplink and downlink. The reporting content may be an actual value or a predicted value. Herein, whether the load is too high and/or whether the load is too low may be an assessment of the overall instances or an individual assessment of an above parameter. The above parameters may also be the load situation and/or resource status of one or more NPNs, or the load situation and/or resource status of one or more NPNs that support access for the purpose of onboarding, or the load situation and/or resource status of one or more NPNs that support access using a credential obtained from a CH. The NPN specific resource situation includes one or more of the following: the resource situation occupied for supporting onboarding, resource situation for supporting access using a credential obtained from a CH, percentage of resources for supporting onboarding, percentage of resources for supporting access using a credential obtained from a CH, etc. Herein, the resource and/or resource situation may be one or more of the above parameters.
Trigger event: used to indicate an event that triggered the reporting, for example, it may include one or more of the following: the change of NPN's resource status and/or load situation is greater than and/or greater than or equal to a certain threshold, the load is too large, the load is too small, the predicted change of NPN's resource status and/or load situation is greater than and/or greater than or equal to a certain threshold, the predicted load is too large, and the predicted load is too small.

### Example 5

An example of the present disclosure proposes a method for supporting non-public network self-optimization, which may include: a second node transmits tenth information including information indicating that NPN information is available to a first node, so as to inform the first node that the second node has stored NPN information, so that the first node can choose whether to obtain the information.

In some implementations, the tenth information may be included in one or more of the following: UE-MeasurementsAvailable, RRCSetupComplete, RRCReestablishmentComplete, RRCReconfigurationComplete, and RRCResumeComplete of RRC; or an other and/or newly defined RRC and/or Xn and/or X2 and/or F1 and/or E1 and/or NG message.

In some implementations, the tenth information may include one or more of the following fields or related information:
UE identification: an identification of a UE related to available NPN information.
Transmitting node identification: an identification of a node that transmits the tenth information.
Receiving node identification: an identification of a node that receives the tenth information.
NPN information available: used for indicating that NPN information is available, or indicating that there is stored NPN information available. This field may be represented by a single bit. When the bit is 1, it means that NPN information is available, and when the bit is 0, it means that NPN information is not available; alternatively, when the bit is 0, it means that NPN information is available, and when the bit is 1, it means that NPN information is not available.
NPN report available: used for indicating that an NPN report is available, or indicating that there is a stored NPN report available. This field may be represented by a single bit. When the bit is 1, it means that the NPN report is available, and when the bit is 0, it means that the NPN report is not available; alternatively, when the bit is 0, it means that the NPN report is available, and when the bit is 1, it means that the NPN report is not available.
NPN failure information available: used for indicating that NPN failure information is available, or indicating that there is stored NPN failure information available. This field may be represented by a single bit. When the bit is 1, it means that NPN failure information is available, and when the bit is 0, it means that NPN failure information is not available; alternatively, when the bit is 0, it means that NPN failure information is available, and when the bit is 1, it means that NPN failure information is not available.
NPN failure report available: used for indicating that an NPN failure report is available, or indicating that there is a stored NPN failure report available. This field may be represented by a single bit. When the bit is 1, it means that the NPN failure report is available, and when the bit is 0, it means that the NPN failure report is not available; alternatively, when the bit is 0, it means that the NPN failure report is available, and when the bit is 1, it means that the NPN failure report is not available.
NPN identification corresponding to report and/or information: used to identify the NPN corresponding to the report and/or information. It may be one or more of the following: Public Land Mobile Network (PLMN) identification, Network Identifier (NID), Closed Access Group (CAG) identification, a combination of PLMN identification and NID, a combination of PLMN identification and CAG identification, etc. It may be an NPN identification corresponding to the NPN information available, an NPN identification corresponding to the NPN report available, an NPN identification corresponding to the NPN failure information available, and an NPN identification corresponding to the NPN failure report available, etc. The identification may be an NPN identification corresponding to the NPN information, an NPN identification corresponding to the NPN report, an NPN identification corresponding to the NPN failure information, and an NPN identification corresponding to the NPN failure report, etc. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. The receiving node of this information may select the report and/or information to request based on this information, and reporting of unnecessary reports and/or information can be avoided.
Identification of that report and/or information is about to time out (expire/time expiring) and/or be discarded: used to indicate that a stored report and/or information is about to time out and/or be discarded, or that there are reports and/or information about to time out and/or be discarded in the stored reports and/or information. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. In an implementation, if the time for storing a report is about to reach a storage time threshold, this information is reported. This information may be used for the receiving node and/or entity of this information to know that the report and/or information is about to time out and/or be discarded, so as to obtain the report and/or information before timeout and/or discard, so as to avoid the loss and waste of the report and/or information.
Time corresponding to report and/or information: used to indicate that the report and/or information is a report and/or information with respect to and/or recorded at one or more certain time points and/or time periods. In an implementation, content described by the report and/or information occurs at one or more certain time points and/or time periods. The report and/or information may be an available report and/or information, or a report and/or information that is about to time out and/or be discarded. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. The receiving node of this information may select the report and/or information to request based on this information, and reporting of unnecessary reports and/or information can be avoided.
Configuration corresponding to report and/or information: used to indicate that the report and/or information is a report and/or information with respect to one or more configurations. In an implementation, the content described by the report and/or information occurs under one or more certain configurations. In an implementation, the configuration may be represented by an index. The index may be Mobility Information. The report and/or information may be an available report and/or information, or a report and/or information that is about to time out and/or be discarded. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. The receiving node of this information may select the report and/or information to request based on this information, and reporting of unnecessary reports and/or information can be avoided.

In some implementations, the first node may transmit eleventh information including a request for NPN information to the second node according to its own situation (autonomously) and/or according to the received information indicating that the NPN information is available, so as to request the second node to report the NPN information, so that the first node can request to obtain the NPN information and perform a self-optimization decision.

The eleventh information may be included in one or more of the following: UEInformationRequest of RRC; or an other and/or newly defined RRC and/or Xn and/or X2 and/or F1 and/or E1 and/or NG message.

In some implementations, the eleventh information may include one or more of the following fields or related information:
UE identification: an identification of a UE related to the requested NPN information.
Transmitting node identification: an identification of a node that transmits the eleventh information.
Receiving node identification: an identification of a node that receives the eleventh information.
NPN information request: used to request NPN information and/or indicate whether NPN information needs to be reported. This field may be represented by a single bit. When the bit is 1, it means that NPN information is requested and/or needs to be reported; and when the bit is 0, it means that NPN information is not requested and/or needs not to be reported; alternatively, when the bit is 0, it means that NPN information is requested and/or needs to be reported; and when the bit is 1, it means that NPN information is not requested and/or needs not to be reported.
NPN report request: used to request an NPN report and/or indicate whether the NPN report needs to be reported. This field may be represented by a single bit. When the bit is 1, it means that NPN report is requested and/or needs to be reported, and when the bit is 0, it means that NPN report is not requested and/or needs not to be reported; alternatively, when the bit is 0, it means that NPN report is requested and/or needs to be reported, and when the bit is 1, it means that NPN report is not requested and/or needs not to be reported.
NPN failure information request: used to request NPN failure information and/or indicate whether NPN failure information needs to be reported. This field may be represented by a single bit. When the bit is 1, it means that NPN failure information is requested and/or needs to be reported, and when the bit is 0, it means that NPN failure information is not requested and/or needs not to be reported; alternatively, when the bit is 0, it means that NPN failure information is requested and/or needs to be reported, and when the bit is 1, it means that NPN failure information is not requested and/or needs not to be reported.
NPN failure report request: used to request an NPN failure report and/or indicate whether the NPN failure report needs to be reported. This field may be represented by a single bit. When the bit is 1, it means that NPN failure report is requested and/or needs to be reported, and when the bit is 0, it means that NPN failure report is not requested and/or needs not to be reported; alternatively, when the bit is 0, it means that NPN failure report is requested and/or needs to be reported, and when the bit is 1, it means that NPN failure report is not requested and/or needs not to be reported.
NPN identification corresponding to report and/or information requested to be reported: used to identify the NPN corresponding to the requested report and/or requested information. It may be one or more of the following: Public Land Mobile Network (PLMN) identification, Network Identifier (NID), Closed Access Group (CAG) identification, a combination of PLMN identification and NID, a combination of PLMN identification and CAG identification, etc. It may be an NPN identification corresponding to an NPN information request, an NPN identification corresponding to an NPN report request, an NPN identification corresponding to an NPN failure information request, an NPN identification corresponding to an NPN failure report available request, etc. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. This information may be used for the node and/or entity receiving this information to report only part of the reports and/or information (for example, report the reports and/or information corresponding to the NPN identification indicated in the request), not all the stored reports and/or information, which may save interface resources and avoid reporting of unnecessary reports and/or information.
Indication of request for reporting report and/or information that is about to time out and/or be discarded: used to indicate that the report and/or information that is about to time out and/or be discarded is requested. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. This information may be used by the receiving node and/or entity of this information to report the report and/or information that is about to time out and/or be discarded, so as to avoid the loss and waste of the report and/or information.
Request for reporting report and/or information corresponding to a specific time (or specified time): used to indicate that the requested report and/or information is a report and/or information with respect to and/or recorded at a specific time (or specified time). In an implementation, the request may include an indication of request for reporting reports and/or information corresponding to a specific time (or a specified time), and/or related information of the specific time (or the specified time). This specific time (or specified time) may be one or more time points and/or time periods. In an implementation, the content described in the requested report and/or information occurs at one or more time points and/or time periods. The report and/or information may be an available report and/or information, and may also be a report and/or information that is about to time out and/or be discarded. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. This information may be used for nodes and/or entities receiving this information to report only part of the reports and/or information (for example, report the reports and/or information corresponding to a specific time (or a specified time)), but not all the stored reports and/or information, which may save interface resources and avoid reporting of unnecessary reports and/or information.
Request for reporting report and/or information corresponding to a specific configuration (or specified configuration): used to indicate that the requested report and/or information is a report and/or information with respect to a specific configuration (or specified configuration, for example, one or more certain configurations). In an implementation, the request may include an indication requesting to report reports and/or information corresponding to a specific configuration (or a specified configuration), and/or related information of the specific configuration (or the specified configuration). In an implementation, the content described by the requested report and/or information occurs under one or more certain configurations. In an implementation, the configuration may be represented by an index. The index may be Mobility Information. The report and/or information may be an available report and/or information, or a report and/or information that is about to time out and/or be discarded. Herein, the report may be a Connection Establishment Failure (CEF) report, a Random Access report, a Successful Handover report, a Radio Link Failure (RLF) report, a measurement report, other reports related to radio connection, NPN related reports, and the above-mentioned NPN reports. Herein, the information may be the above-mentioned NPN related information. This information may be used for nodes and/or entities that receive this information to report only part of the reports and/or information (for example, report reports and/or information corresponding to a specific configuration (or a specified configuration)), but not all the stored reports and/or information, which may save interface resources and avoid reporting of unnecessary reports and/or information.

In some implementations, the second node may transmit twelfth information including NPN information to the first node according to its own situation (autonomously) and/or according to a request for the NPN information, so as to provide reference information for the first node to perform a self-optimization decision.

In some implementations, the twelfth information may be included in one or more of the following: UEInformationResponse, SCGFailureInformation, and MCGFailureInformation of RRC; a FAILURE INDICATION message, a HANDOVER REPORT message, an ACCESS AND MOBILITY INDICATION message, an S-NODE MODIFICATION REQUEST message, a SgNB MODIFICATION REQUEST message, a SCG FAILURE INFORMATION REPORT message, a RRC TRANSFER message of Xn; an ACCESS AND MOBILITY INDICATION message of F1; an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message. This information may be included in a report, herein the report may be a Connection Establishment Failure (CEF) report, a Random Access report, a Successful Handover report, a Radio Link Failure (RLF) report, a measurement report, or other reports related to wireless connection. The report may also be a new report, for example, it may be one or more of the following: an NPN failure report, an NPN report, a continuous NPN failure report, etc.

In some implementations, the twelfth information may include one or more of the following fields or related information:
UE identification: used to identify the UE performing NPN access.
Node identification: used to identify a node identification corresponding to an NPN access performed by the UE.
Cell identification: used to identify a cell identification corresponding to an NPN access performed by the UE.
NPN identification: used to identify the NPN accessed by the UE. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Time from access to reporting: used to indicate the time from NPN access to NPN information reporting by the UE. In an implementation, this time may be used for a node and/or entity to find related configuration, and the node and/or entity may perform self-optimization such as configuration update on the related configuration.
Time from access failure to reporting: used to indicate the time from the occurrence of NPN access failure to NPN information reporting. In an implementation, this time may be used for a node and/or entity to find related configuration, and the node and/or entity may perform self-optimization such as configuration update on the related configuration.
Time from access attempt to reporting: used to indicate the time from attempting to access an NPN to NPN information reporting. In an implementation, this time may be used for a node and/or entity to find related configuration, and the node and/or entity may perform self-optimization such as configuration update on the related configuration.
Time from handover to reporting: used to indicate the time from the occurrence of handover to NPN information reporting. The handover may include handover from an NPN to an NPN, from an ordinary cell to an ordinary cell, from an NPN to an ordinary cell, and from an ordinary cell to an NPN, etc. In an implementation, this time may be used for a node and/or entity to find related configuration, and the node and/or entity may perform self-optimization such as configuration update on the related configuration.
Reason and/or access reason and/or registration reason: indicating a reason for a UE to access and/or register an NPN, or a reason for handover and/or a requirement for handover, or a reason for adding nodes and/or modifying nodes and/or releasing nodes, or a reason for adding secondary nodes and/or modifying secondary nodes and/or releasing secondary nodes, or a reason for mobility decision, etc. It may include one or more of the following: Onboarding, access using a credential obtained from a CH, normal access, etc.
Purpose and/or access purpose and/or registration purpose: indicating a purpose for a UE to access and/or register an NPN, or a purpose for handover, or a purpose for adding nodes and/or modifying nodes and/or releasing nodes, or a purpose for adding secondary nodes and/or modifying secondary nodes and/or releasing secondary nodes, or a purpose for mobility decision, etc. It may include one or more of the following: Onboarding, access using a credential obtained from a CH, normal access, etc.
Way for accessing and/or registering NPN: indicates the way for a UE to access and/or register an NPN. It may include: Onboarding, access using a credential obtained from a CH, normal access, etc. It may indicate the way that the UE accesses and/or registers a cell where radio link failure occurs, or it may also indicate the way that the UE accesses and/or registers the last connected cell. Normal access may also be ordinary access. In an implementation, this information may be used by nodes and/or entities to analyze whether a configuration is suitable and/or whether a decision is suitable. For example, if the UE needs to access a desired NPN through a way of onboarding, the cell to be switched and/or accessed can only be selected among cells that support UE onboarding and/or that support UE access to the desired NPN. This field may include one or more of the following:
   Whether to register and/or access an NPN through onboarding
   Whether accessing and/or registering an NPN is for onboarding access to other NPNs
   Whether to register and/or access an NPN using a credential obtained from a CH
   Whether is it a normal access
   Reconnected NPN identification: used to identify the NPN that the UE reconnects. It may be one or more of the following: Public Land Mobile Network (PLMN) identification, Network Identifier (NID), Closed Access Group (CAG) identification, a combination of PLMN identification and NID, a combination of PLMN identification and CAG identification, etc. In an implementation, this information may be used by nodes and/or entities to analyze whether the selection of a target node and/or cell is suitable and/or whether the selection of a handover timing is suitable, and/or to analyze reasons for handover failure and/or radio link failure (e.g., too early handover, too late handover, handover to a wrong cell, handover error, unnecessary handover, handover ping-pong, etc.), and/or to perform self-optimization such as handover and/or configuration update, etc.
   Reconnected cell identification: used to identify the NPN and/or cell identification that the UE reconnects. Herein, the NPN identification may be one or more of the following: Public Land Mobile Network (PLMN) identification, Network Identifier (NID), Closed Access Group (CAG) identification, a combination of PLMN identification and NID, a combination of PLMN identification and CAG identification, etc. In an implementation, this information may be used by nodes and/or entities to analyze whether the selection of a target node and/or cell is suitable and/or whether the selection of a handover timing is suitable, and/or to analyze reasons for handover failure and/or radio link failure (e.g., too early handover, too late handover, handover to a wrong cell, handover error, unnecessary handover, handover ping-pong, etc.), and/or to perform self-optimization such as handover and/or configuration update, etc.
   Indication of whether to handover from an NPN to an ordinary cell: used to indicate whether to handover from an NPN to an ordinary cell.
   Indication of whether to handover from an ordinary cell to an NPN: used to indicate whether to handover from an ordinary cell to an NPN.
   Group IDs for Network selection (GINs): used to indicate GINs and/or a list of GINs corresponding to Onboarding access and/or access using a credential obtained from a CH. In an implementation, this information is used for nodes and/or entities to judge whether the selection of a target node and/or cell is suitable and whether update or self-optimization is needed.
   GINs of an accessing cell: in an implementation, this information may be used for nodes and/or entities to analyze whether mobility decisions are suitable and/or update the determination and/or configuration of mobility decisions, for example, to analyze whether the selection of a target cell and/or cell is suitable and whether update or self-optimization is needed.
   GINs of a neighboring cell: in an implementation, this information may be used for nodes and/or entities to analyze whether mobility decisions are suitable and/or update the determination and/or configuration of mobility decisions. For example, this information may be used for nodes and/or entities to analyze whether the selection of a target node selection is suitable and whether the decision-making and/or configuration need to be updated.
   Identification of a target NPN and/or desired NPN: indicating an identification of an NPN network that a UE actually wants to access. It may be one or more of the following: Public Land Mobile Network (PLMN) identification, Network Identifier (NID), Closed Access Group (CAG) identification, a combination of PLMN identification and NID, a combination of PLMN identification and CAG identification, etc. In an implementation, this information may be used for nodes and/or entities to analyze whether mobility decisions are suitable and/or update the determination and/or configuration of mobility decisions. For example, this information may be used for nodes and/or entities to analyze target node and/or cell selection. In an implementation, the target node can only be selected from the cells and/or nodes that support the user to obtain the service of a target NPN and/or a desired NPN.
   Network selection mode: it may include one or more of the following: manual selection, automatic selection, etc.
   Cause: indicating the reason for access and/or handover failure and/or radio link failure and/or random access failure and/or the reason why a required service cannot be provided. The cause may include one or more of the following: a target cell and/or a neighboring cell and/or one or more specific cells and/or a serving cell do not support Onboarding, no cell supports Onboarding, a target cell and/or a neighboring cell and/or one or more specific cells and/or a serving cell do not support access using a credential obtained from a CH, no cell supports access using a credential obtained from a CH, GIN of a target cell and/or a neighboring cell and/or one or more specific cells and/or a serving cell is different from that of a source cell and/or serving cell, no cell has a GIN that is different from that of a source cell and/or serving cell, GIN of a target cell and/or a neighboring cell and/or one or more specific cells and/or a serving cell does not support access to a target NPN and/or a desired NPN identification, no cell has a GIN that supports access to a target NPN and/or a desired NPN identification, GIN of a target cell and/or a neighboring cell and/or one or more specific cells and/or a serving cell does not support access to a target NPN and/or a desired NPN, no cell supports access to a target NPN and/or a desired NPN, a target cell and/or a neighboring cell and/or one or more specific cells and/or a serving cell cannot establish a Protocol Data Unit Session corresponding to the NPN, no cell can establish a protocol data unit session corresponding to the NPN, a target cell and/or a neighboring cell and/or one or more specific cells and/or a service cell cannot establish a Data Radio Bearer corresponding to the NPN, no cell can establish a Data Radio Bearer corresponding to the NPN, a target cell and/or a neighboring cell and/or one or more specific cells and/or a service cell cannot establish a Quality of Service Flow corresponding to the NPN, and no cell can establish a Quality of Service Flow corresponding to the NPN. In an implementation, this information may help nodes and/or entities to analyze reasons for radio link failure, etc., in order for the nodes and/or entities to perform configuration and/or decision update according to the analyzed reasons.
   Event: indicating an event that occurs, which may be an event that occurs at a time point and/or within a time period. The event may include one or more of the following: a target cell and/or a neighboring cell and/or one or more specific cells and/or a serving cell do not support Onboarding, no cell supports Onboarding, a target cell and/or a neighboring cell and/or one or more specific cells and/or a serving cell do not support access using a credential obtained from a CH, no cell supports access using a credential obtained from a CH, GIN of a target cell and/or a neighboring cell and/or one or more specific cells and/or a serving cell is different from that of a source cell and/or serving cell, no cell has a GIN that is the same as that of a source cell and/or serving cell, GIN of a target cell and/or a neighboring cell and/or one or more specific cells and/or a serving cell does not support access to a target NPN and/or a desired NPN identification, no cell has a GIN that supports access to a target NPN and/or a desired NPN identification, GIN of a target cell and/or a neighboring cell and/or one or more specific cells and/or a serving cell does not support access to a target NPN and/or a desired NPN, no cell supports access to a target NPN and/or a desired NPN, a target cell and/or a neighboring cell and/or one or more specific cells and/or a serving cell cannot establish a Protocol Data Unit Session corresponding to the NPN, no cell can establish a protocol data unit session corresponding to the NPN, a target cell and/or a neighboring cell and/or one or more specific cells and/or a service cell cannot establish a Data Radio Bearer corresponding to the NPN, no cell can establish a Data Radio Bearer corresponding to the NPN, a target cell and/or a neighboring cell and/or one or more specific cells and/or a service cell cannot establish a Quality of Service Flow corresponding to the NPN, and no cell can establish a Quality of Service Flow corresponding to the NPN. In an implementation, this information may help nodes and/or entities to analyze reasons for radio link failure, etc., in order for the nodes and/or entities to perform configuration and/or decision update according to the analyzed reasons.
   Measurement result of signal strength and/or signal quality: the measurement result of signal strength and/or signal quality may be a measurement result at a time point and/or a time period, or a measurement result corresponding to the above events and/or causes.

In some implementations, when for one or more cells and/or neighboring cells, signal strength and/or signal quality measurement results are greater than and/or equal to and/or less than a threshold, and/or an NPN access requirement is not met, for example, Onboarding is not supported, access using a credential obtained from a CH is not supported, GIN is different from that of a source cell and/or serving cell, GIN does not support access to a target NPN and/or desired NPN, Protocol Data Unit Session corresponding to an NPN cannot be established, Data Radio Bearer corresponding to an NPN cannot be established, Quality of Service Flow corresponding to an NPN cannot be established, etc., the node may not record relevant NPN information. For example, if the user measures that the signal strength and/or signal quality of a cell is greater than and/or equal to a threshold, but the cell does not support the NPN access requirement of the node, the user does not record information of the cell, to avoid the serving node and/or other nodes misjudging a wrong self-optimization decision. For example, the reason why the user's radio link fails is that the neighboring cell does not support the user's NPN access requirements so that handover cannot be performed, but not that the handover is not performed in time, so the serving node and/or other nodes don't need to update their handover decisions to avoid unnecessary updates affecting the network performance.

In some implementations, after the first node collects the NPN information of the NPN of the second node (and/or the third node), the first node can perform a self-optimization decision and/or update configurations, or the first node can transmit the collected NPN information to other nodes to provide reference information for the other nodes to perform a self-optimization decision and/or update configurations.

### Example 6

An example of the present disclosure proposes a method for supporting non-public network self-optimization, which may include: a first node transmits thirteenth information including an NPN function activation request to a second node to request the second node to activate some or all functions of the NPN. In some implementations, for example, the second node informs the first node of NPN functions of the second node (for example, it may be informed by the second information), and the first node requests to enable functions that the second node has not enabled in some cases. Herein, the some cases may be that the first node needs to handover the user to the second node, or the first node needs to handover the user to the second node because the first node needs to disable some functions due to energy saving, or the first node needs to handover some users to the second node because of load balancing decision. In this way, energy can be saved under the condition of satisfying performance, and it can be avoided that performance is affected by energy saving.

In some implementations, the thirteenth information may be included in one or more of the following: a CELL ACTIVATION REQUEST message or a CELL ACTIVATION RESPONSE message or a CELL ACTIVATION FAILURE message of Xn; or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the thirteenth message may include one or more of the following fields or related information:
Transmitting node identification: an identification of a node that transmits the thirteenth information.
Receiving node identification: an identification of a node that receives the thirteenth information.
Activation request identification: used to identify the request.
NPN identification: used to identify an NPN requested to be activated. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Request to activate an onboarding function: used to request to activate the onboarding function of an NPN, to allow registration for a purpose of onboarding in a cell.
Request to activate a function of performing access using a credential obtained from a CH: used to request to activate a function of performing access using a credential obtained from a CH, to allow registration and/or access using a credential obtained from a CH in a cell.
Cause for requesting for activation: it may include energy saving, excessive load, etc.

In some implementations, the second node may transmit fourteenth information including an NPN function activation result (for example, of the second node) to the first node according to its own situation and/or according to the received thirteenth information including an NPN function activation request, so as to inform the first node of the NPN function activation result in the second node.

In some implementations, the fourteenth information may be included in one or more of the following: a CELL ACTIVATION REQUEST message or a CELL ACTIVATION RESPONSE message or a CELL ACTIVATION FAILURE message of Xn; or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1 or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the fourteenth message may include one or more of the following fields or related information:
Transmitting node identification: an identification of a node that transmits the fourteenth information.
Receiving node identification: an identification of a node that receives the fourteenth information.
Activation request identification: used to identify the request.
Successfully activated NPN identification: an identification used to identify a successfully activated NPN. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Identification of an NPN for which an onboarding function is successfully activated: used to identify an NPN for which an onboarding function is successfully activated, which indicates that registration for a purpose of onboarding is allowed in a cell. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Identification of an NPN for which a function of performing access using a credential obtained from a CH is successfully activated: used to identify an NPN for which a function of performing access using a credential obtained from a CH is successfully activated, which indicates that registration and/or access using a credential obtained from a CH is allowed in a cell. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Identification of successful activation of an onboarding function: used to identify that an onboarding function of an NPN is successfully activated, which allows registration for a purpose of onboarding in a cell.
Identification of successful activation of a function of performing access using a credential obtained from a CH: used to identify that a function of performing access using a credential obtained from a CH of an NPN is successfully activated, which allows registration and/or access using a credential obtained from a CH in a cell.
Time of successful activation: indicates a time point and/or time period of successful activation.
Identification of an NPN with failed activation: an identification used to identify an NPN for which the activation is failed. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Identification of an NPN for which activation of an onboarding function is failed: used to identify an NPN for which activation of an onboarding function is failed, which indicates that registration for a purpose of onboarding is not allowed in a cell. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Identification of an NPN for which activation of a function of performing access using a credential obtained from a CH is failed: used to identify an NPN for which activation of a function of performing access using a credential obtained from a CH is failed, which indicates that registration and/or access using a credential obtained from a CH is not allowed in a cell. It may be one or more of the following: Public Land Mobile Network (PLMN) identification, Network Identifier (NID), Closed Access Group (CAG) identification, a combination of PLMN identification and NID, a combination of PLMN identification and CAG identification, etc.
Identification of failed activation of an onboarding function: used to identify that activation of an onboarding function of an NPN is failed, which allows registration for a purpose of onboarding in a cell.
Identification of failed activation of a function of performing access using a credential obtained from a CH: used to identify that activation of a function of performing access using a credential obtained from a CH of an NPN is failed, which allows registration and/or access using a credential obtained from a CH in a cell.
Time of activation failure: indicates a time point and/or time period of activation failure.
Cause for successful activation
Cause for activation failure: it may include energy saving, a function is unavailable, a function is not supported, etc.

The methods performed by the first node and/or the second node in the wireless communication system according to embodiments of the present disclosure can be used for network self-optimization decision. The network self-optimization decision mentioned in the present disclosure may include at least one of network energy saving, load balancing, coverage optimization, mobility optimization and/or management, network configuration determination and/or network configuration updating, etc.

In addition, a result and a report in the present disclosure may refer to each other.

A target NPN and/or a desired NPN in the present disclosure may be identified as an NPN network that a UE actually wants to access. For example, in the case of Onboarding access, an NPN whose credential would like to be obtained is the target NPN and/or the desired NPN identification. For example, in the case of accessing the network using a credential obtained from a credential holder (CH), an NPN would like to be accessed actually is the target NPN and/or the desired NPN identification.

In the present disclosure, accessing network may be used interchangeably with registering network.

In the present disclosure, the cause/reason may indicate the purpose or a way been used.

In the present disclosure, fields and/or information may be measured values, actual values, predicted values, maximum values, minimum values, average values, latest values and the like of the information.

In the present disclosure, “enable” and “activate” may refer to each other, and “not enable” and “deactivate” and/or “not activate” may refer to each other.

In the present disclosure, nodes and/or entities may also refer to cells managed by the nodes and/or entities.

In the present disclosure, an ordinary access and/or a normal access means accessing without onboarding, an access without using a credential obtained from a CH, an access without onboarding, etc. In an implementation, an ordinary access and/or a normal access means an access using an NPN's own credential to obtain the service of this NPN network.

In addition, in the present disclosure, time may be expressed by one or more of the following methods: time stamp, time point, time interval, timer, period of time, time length, time period/periodicity, time spacing, etc. Herein, the time length may be a time length from a certain time point, which may be the current time. The time may be a relative time or an absolute time. In an implementation, the period of time may be represented by separate fields, for example, by a combination of a start time and an end time, or by a combination of a start time and a period of time.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the disclosure herein, it is apparent to those skilled in the art that changes can be made to the illustrated embodiments and examples without departing from the scope of the present disclosure.

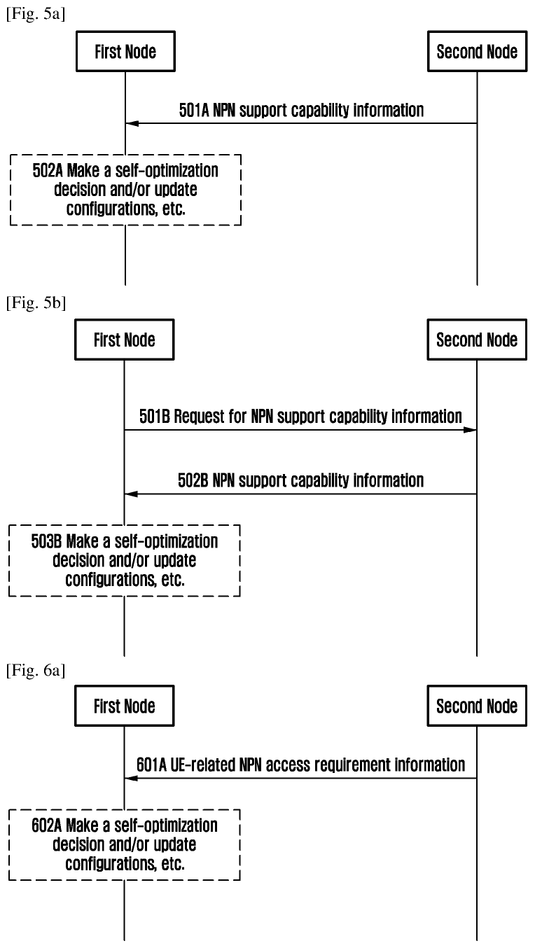

FIG. 5A illustrates a schematic diagram of an aspect of a method for supporting non-public network self-optimization according to embodiments of the present disclosure. Specifically, FIG. 5A shows a process of exchanging NPN support capability information between two nodes, so that the first node can obtain NPN support capability information and perform a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 501A: the second node transmits NPN support capability information to the first node. The NPN support capability information may be the aforementioned second information.

Step 502A: the first node makes a self-optimization decision and/or updates configurations based on the obtained NPN support capability information. In some implementations, when the first node makes a handover decision for a UE, it selects a node of an NPN that can support access by the UE as a handover target node.

FIG. 5B illustrates a schematic diagram of an aspect of a method for supporting non-public network self-optimization according to embodiments of the present disclosure. Specifically, FIG. 5B shows a process of exchanging NPN support capability information between two nodes, so that the first node can obtain NPN support capability information and perform a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 501B: the first node transmits a request for NPN support capability information to the second node. The request for NPN support capability information may be the aforementioned first information.

Step 502B: the second node transmits NPN support capability information to the first node. The NPN support capability information may be the aforementioned second information.

Step 503B: the first node makes a self-optimization decision and/or updates configurations based on the obtained NPN support capability information. In some implementations, when the first node makes a handover decision for a UE, it selects a node of an NPN that can support access by the UE as a handover target node.

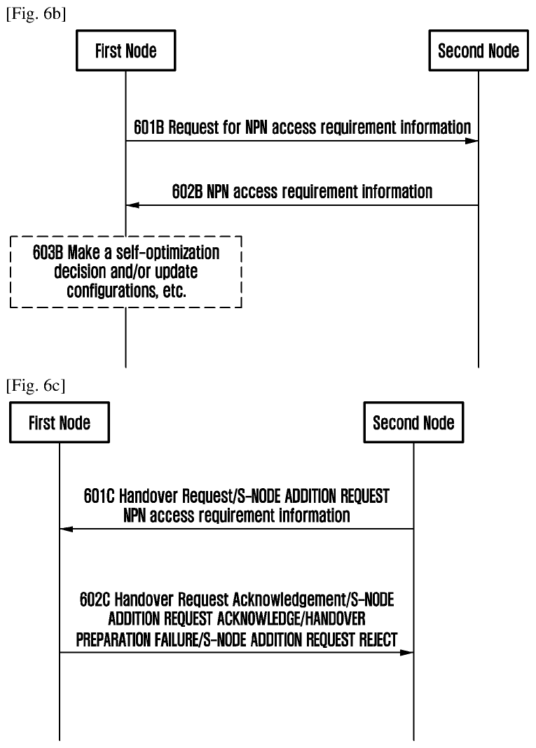

FIG. 6A illustrates a schematic diagram of an aspect of a method for supporting non-public network self-optimization according to embodiments of the present disclosure. Specifically, FIG. 6A shows a process of exchanging NPN access requirement information of a UE between two nodes, so that the first node can obtain the NPN access requirement information and make a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 601A: the second node transmits NPN access requirement information of a UE to the first node. The NPN access requirement information may be the aforementioned fourth information.

Step 602A: the first node makes a self-optimization decision and/or updates configurations based on the obtained NPN access requirement information. In some implementations, the first node carries (e.g., transmits to a target node) NPN access requirement information when making a handover request for a UE, and the target node accepts and/or rejects the handover request according to the NPN access requirement information, for example, when the target node can support the NPN access requirement, the handover request is accepted; and when the target node cannot support the NPN access requirement, the handover request is rejected.

FIG. 6B illustrates a schematic diagram of an aspect of a method for supporting non-public network self-optimization according to embodiments of the present disclosure. Specifically, FIG. 6B shows a process of exchanging NPN access requirement information of a UE between two nodes, so that the first node can obtain the NPN access requirement information of the UE and make a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 601B: the first node transmits a request for NPN access requirement information to the second node. The request for NPN access requirement information may be the aforementioned third information.

Step 602B: the second node transmits the NPN access requirement information to the first node. The NPN access requirement information may be the aforementioned fourth information.

Step 603B: the first node makes a self-optimization decision and/or updates configurations based on the obtained NPN access requirement information. In some implementations, the first node carries (e.g., transmits to a target node) NPN access requirement information when making a handover request for a UE, and the target node accepts and/or rejects the handover request according to the NPN access requirement information, for example, when the target node can support the NPN access requirement, the handover request is accepted; and when the target node cannot support the NPN access requirement, the handover request is rejected.

FIG. 6C illustrates a schematic diagram of an aspect of a method for supporting non-public network self-optimization according to embodiments of the present disclosure. Specifically, FIG. 6C shows a process of exchanging NPN access requirement information of a UE between two nodes, so that the first node can obtain the NPN access requirement information of the UE and make a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 601C: the second node transmits NPN access requirement information to the first node. The NPN access requirement information may be the aforementioned fourth information. The NPN access requirement information may be transmitted through a Handover Request and/or an S-NODE ADDITION REQUEST message.

Step 602C: the first node makes a response according to the NPN access requirement information and its own NPN support capability information. For example, the response may be to accept the Handover Request and/or the S-NODE ADDITION REQUEST when the first node can support the NPN access requirement; and to reject the Handover Request and/or the S-NODE ADDITION REQUEST when the first node cannot support the NPN access requirement. The response may be transmitted through a Handover Request Acknowledgement and/or S-NODE ADDITION REQUEST ACKNOWLEDGE (e.g., S-NODE ADDITION REQUEST ACKNOWLEDGE, SENB ADDITION REQUEST ACKNOWLEDGE, or SGNB ADDITION REQUEST ACKNOWLEDGE, etc.) and/or HANDOVER PREPARATION FAILURE and/or S-NODE ADDITION REQUEST REJECT (e.g., S-NODE ADDITION REQUEST REJECT, SENB ADDITION REQUEST REJECT, or SGNB ADDITION REQUEST REJECT, etc.) message.

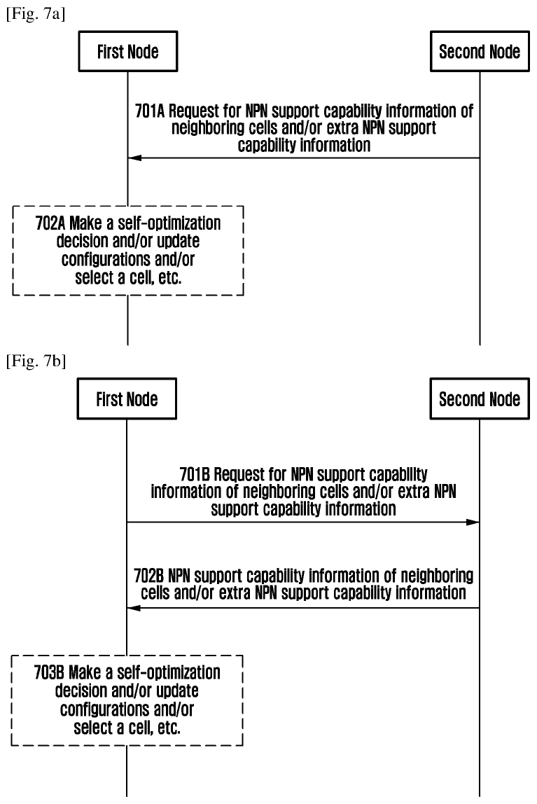

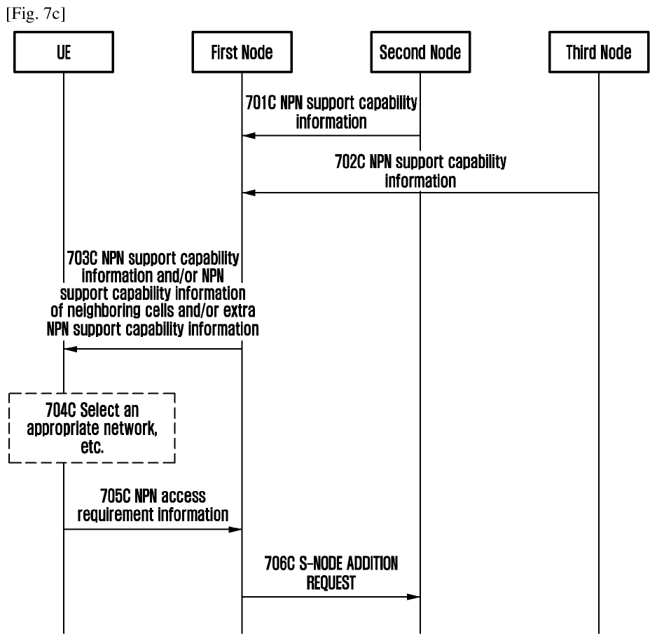

FIG. 7A illustrates a schematic diagram of an aspect of a method for supporting non-public network self-optimization according to embodiments of the present disclosure. Specifically, FIG. 7A shows a process of exchanging NPN support capability information of neighboring cells and/or extra NPN support capability information between two nodes, so that the first node can obtain NPN support capability information and makes a self-optimization decision and/or update configurations and/or select a cell. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 701A: the second node transmits NPN support capability information of neighboring cells and/or extra NPN support capability information of the second node (and/or a third node) to the first node. The NPN support capability information of neighboring cells and/or extra NPN support capability information may be the aforementioned sixth information.

Step 702A: the first node makes a self-optimization decision and/or updates configurations and/or selects a cell based on the obtained NPN support capability information of neighboring cells and/or extra NPN support capability information. In some implementations, for example, the first node is a UE and the second node is a base station. After receiving the NPN support capability information of neighboring cells and/or extra NPN support capability information broadcast by the base station, the UE selects a cell that can support the NPN access requirement of the UE for access.

FIG. 7B illustrates a schematic diagram of an aspect of a method for supporting non-public network self-optimization according to embodiments of the present disclosure. Specifically, FIG. 7B shows a process of exchanging NPN support capability information of neighboring cells and/or extra NPN support capability information between two nodes, so that the first node can obtain NPN support capability information and makes a self-optimization decision and/or update configurations and/or select a cell. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 701B: the first node transmits a request for NPN support capability information of neighboring cells and/or extra NPN support capability information to the second node. The request for the NPN support capability information of neighboring cells and/or extra NPN support capability information may be the aforementioned fifth information.

Step 702B: the second node transmits the NPN support capability information of neighboring cells and/or extra NPN support capability information to the first node. The NPN support capability information of neighboring cells and/or extra NPN support capability information may be the aforementioned sixth information.

Step 703B: the first node makes a self-optimization decision and/or updates configurations and/or selects a cell based on the obtained NPN support capability information of neighboring cells and/or extra NPN support capability information. In some implementations, for example, the first node is a UE and the second node is a base station. After receiving the NPN support capability information of neighboring cells and/or extra NPN support capability information broadcast by the base station, the UE selects a cell that can support the NPN access requirement of the UE for access.

FIG. 7C illustrates a schematic diagram of an aspect of a method for supporting non-public network self-optimization according to embodiments of the present disclosure. Specifically, FIG. 7C shows a process of exchanging NPN support capability information and NPN support capability information of neighboring cells and/or extra NPN support capability information between nodes and between nodes and UE, so that the UE can obtain NPN support capability information and select an appropriate cell, etc. In some implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. The third node may be a gNB or gNB-CU or gNB-DU or gNB CU-CP or gNB CU-UP or en-gNB or eNB or ng-eNB.

Step 701C: the second node transmits the NPN support capability information of the second node to the first node. The NPN support capability information may be the aforementioned second information.

Step 702C: the third node transmits the NPN support capability information of the third node to the first node. The NPN support capability information may be the aforementioned second information.

Step 703C: the first node determines NPN support capability information of neighboring cells and/or extra NPN support capability information based on the received NPN support capability information of the neighboring cells/nodes (for example, the second node and the third node). The first node transmits NPN support capability information and/or NPN support capability information of neighboring cells and/or extra NPN support capability information to the UE. The NPN support capability information may be the aforementioned second information. The NPN support capability information of neighboring cells and/or extra NPN support capability information may be the aforementioned sixth information.

Step 704C: the UE selects an appropriate network for access. In some implementations, after receiving NPN support capability information and/or NPN support capability information of neighboring cells and/or extra NPN support capability information, the UE selects a cell that can support the NPN access requirement of the UE for access.

Step 705C: the UE transmits the NPN access requirement information to the first node. The NPN access requirement information may be the aforementioned fourth information.

Step 706C: the first node makes a self-optimization decision according to the received NPN access requirement information of the UE, for example, adding an other node as a secondary node in the dual-connectivity, etc. As an example, the first node transmits an S-NODE ADDITION REQUEST message to a second node.

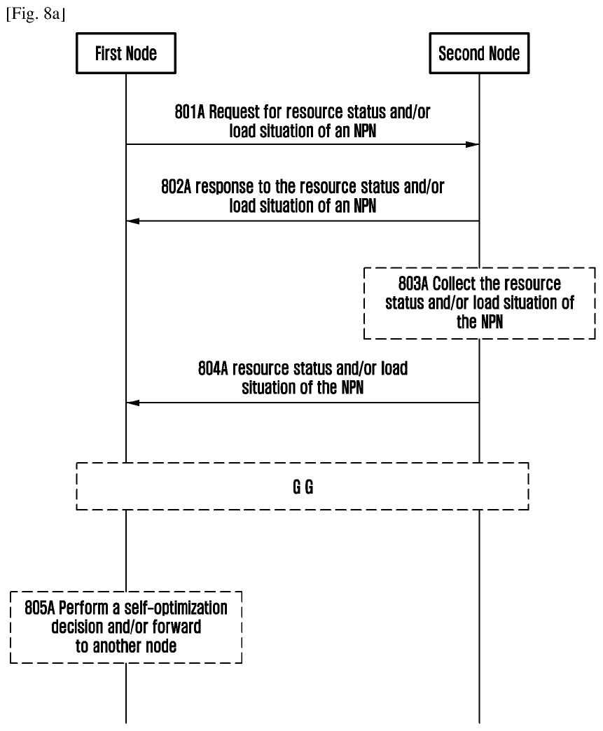

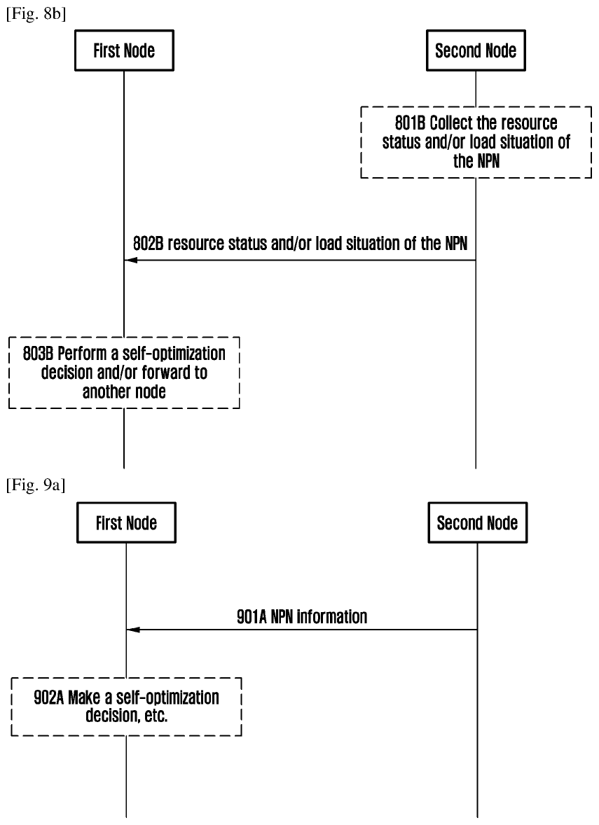

FIG. 8A illustrates a schematic diagram of an aspect of a method for supporting non-public network self-optimization according to embodiments of the present disclosure. Specifically, FIG. 8A shows a process of exchanging resource status and/or load situation of an NPN between two nodes, so that the first node can obtain the resource status and/or load situation of an NPN of the second node and/or other nodes, so as to provide reference information for the first node to perform a self-optimization decision.

In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB CU-CP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 801A: the first node transmits a request for resource status and/or load situation of an NPN to the second node. The request for resource status and/or load situation of an NPN may be the aforementioned seventh information.

Step 802A: the second node transmits a response to the request for resource status and/or load situation of an NPN to the first node. The response to the request for resource status and/or load situation of an NPN may be the aforementioned eighth information.

Step 803A: the second node collects the resource status and/or load situation of the NPN.

Step 804A: the second node transmits the resource status and/or load situation of the NPN to the first node. The resource status and/or load situation of the NPN may be the aforementioned ninth information.

Step 805A: the first node performs network self-optimization decision setting based on the obtained resource status and/or load situation of the NPN and/or forwards it to other nodes.

If the request information in step 801A requires the second node to report periodically, steps 803A and 804A are performed periodically.

FIG. 8B illustrates a schematic diagram of an aspect of a method for supporting non-public network self-optimization according to embodiments of the present disclosure. Specifically, FIG. 8B shows a process of exchanging resource status and/or load situation of an NPN between two nodes, so that the first node can obtain the resource status and/or load situation of an NPN of the second node and/or other nodes, so as to provide reference information for the first node to perform a self-optimization decision.

In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB CU-CP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 801B: the second node collects the resource status and/or load situation of the NPN.

Step 802B: the second node transmits the resource status and/or load situation of the NPN to the first node. The resource status and/or load situation of the NPN may be the aforementioned ninth information.

Step 803B: the first node performs network self-optimization decision setting based on the obtained resource status and/or load situation of the NPN and/or forwards it to other nodes.

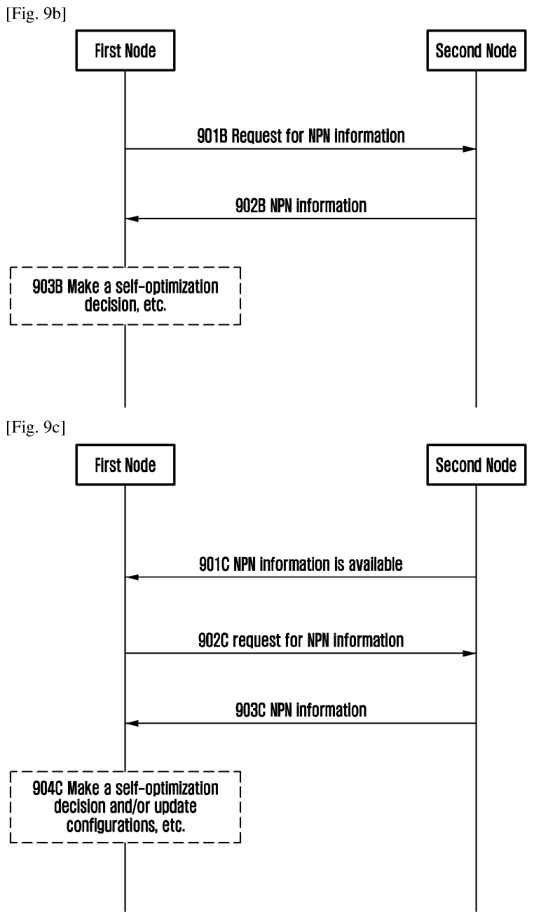

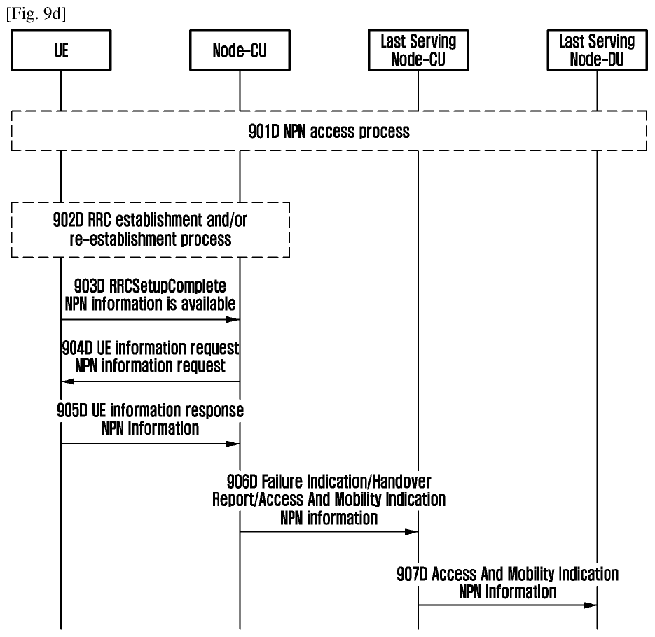

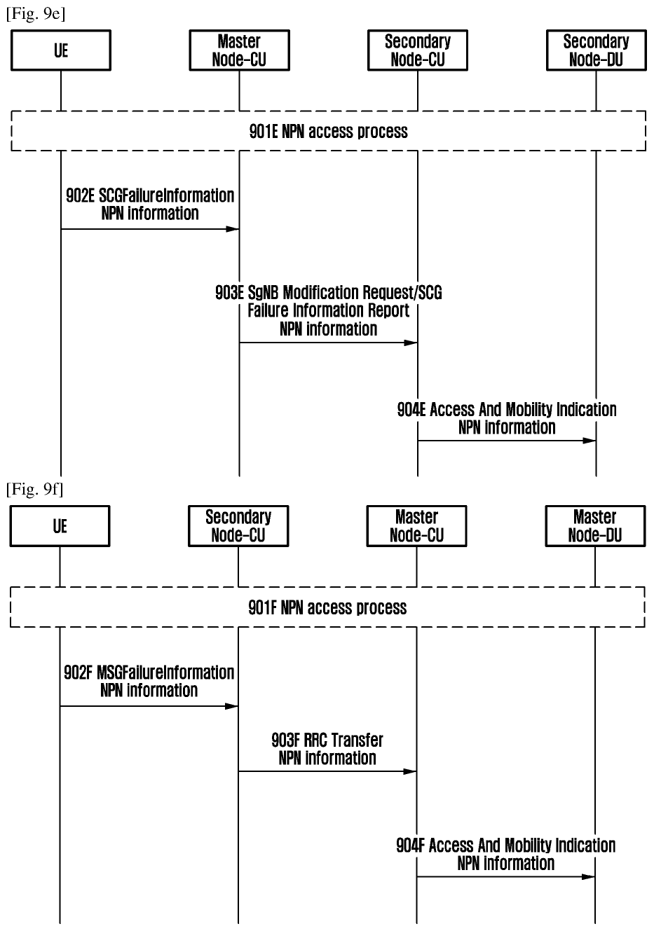

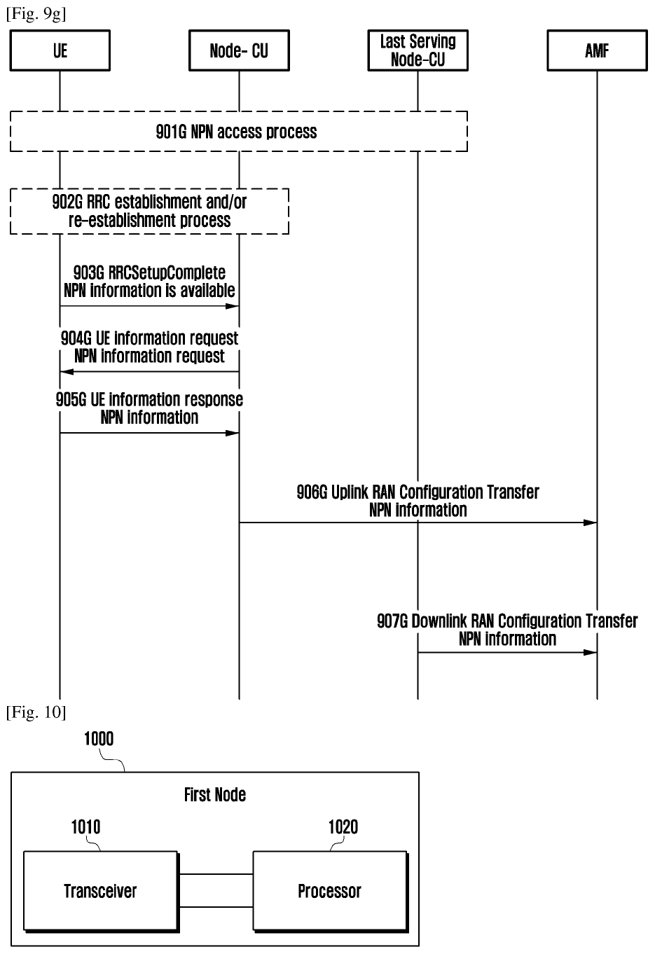

FIG. 9A illustrates a schematic diagram of an aspect of a method for supporting non-public network self-optimization according to embodiments of the present disclosure. Specifically, FIG. 9A shows a process of exchanging NPN information between two nodes, so that the first node can obtain NPN information and make a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 901A: the second node transmits the NPN information to the first node. The NPN information may be the aforementioned twelfth information.

Step 902A: the first node makes a self-optimization decision and/or updates configurations based on the obtained NPN information.

FIG. 9B illustrates a schematic diagram of an aspect of a method for supporting non-public network self-optimization according to embodiments of the present disclosure. Specifically, FIG. 9B shows a process of exchanging NPN information between two nodes, so that the first node can obtain NPN information and make a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 901B: the first node transmits a request for NPN information to the second node. The request for NPN information may be the aforementioned eleventh information.

Step 902B: the second node reports the NPN information to the first node. The NPN information may be the aforementioned twelfth information.

Step 903B: the first node makes a self-optimization decision and/or updates configurations based on the obtained NPN information.

FIG. 9C illustrates a schematic diagram of an aspect of a method for supporting non-public network self-optimization according to embodiments of the present disclosure. Specifically, FIG. 9C shows a process of exchanging NPN information between two nodes, so that the first node can obtain NPN information and make a self-optimization decision and/or update configurations. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 901C: the second node transmits information indicating that NPN information is available to the first node, so as to inform the first node that the second node has NPN information. The information indicating that NPN information is available may be the aforementioned tenth information.

Step 902C: the first node transmits a request for NPN information to the second node. The request for NPN information may be the aforementioned eleventh information.

Step 903C: the second node reports the NPN information to the first node. The NPN information may be the aforementioned twelfth information.

Step 904C: the first node makes a self-optimization decision and/or updates configurations based on the obtained NPN information.

FIG. 9D illustrates a schematic diagram of an aspect of a method for supporting non-public network self-optimization according to embodiments of the present disclosure. Specifically, FIG. 9D shows a process of exchanging NPN information among a user, a node and a last serving node, so that the last serving node can obtain NPN information, so that the last serving node can make configuration adjustment and make a self-optimization decision. As described above, a node may be a base station, which may include a Central Unit (CU) and a distributed unit (DU), and the CU may also include a user plane (UP) and a control plane (CP).

Step 901D: the UE performs an NPN access process with the last serving node (or the CU of the last serving node and/or the DU of the last serving node).

Step 902D: the UE performs RRC establishment and/or re-establishment with the node (or the CU of the node).

Step 903D: the UE transmits information indicating that the NPN information is available to the node (or the CU of the node), so as to inform the node (or the CU of the node) that the UE has the NPN information. The information indicating that NPN information is available may be the aforementioned tenth information. The information indicating that the NPN information is available may be transmitted through an RRCSetupComplete message.

Step 904D: the node (or the CU of the node) transmits a request for NPN information to the UE to request the UE to report the NPN information. The request for NPN information may be the aforementioned eleventh information. The request for NPN information may be transmitted through a UEInformationRequest message.

Step 905D: the UE transmits NPN information to the node (or the CU of the node). The NPN information may be the aforementioned twelfth information. The NPN information may be transmitted through a UEInformationResponse message.

Step 906D: the node (or the CU of the node) transmits NPN information to the last serving node (or the CU of the last serving node). The NPN information may be the aforementioned twelfth information. The NPN information may include all the information and/or part of the information in step 905D. The NPN information may be transmitted through a Failure Indication and/or a Handover Report and/or an Access And Mobility Indication message.

Step 907D: the CU of the last serving node transmits NPN information to the DU of the last serving node. The NPN information may be the aforementioned twelfth information. The NPN information may include all the information and/or part of the information in step 906D. The NPN information may be transmitted through an Access And Mobility Indication message.

The last serving node (or the CU of the last serving node, or the DU of the last serving node) may perform a self-optimization decision and/or update configurations based on the received NPN information.

FIG. 9E illustrates a schematic diagram of an aspect of a method for supporting non-public network self-optimization according to embodiments of the present disclosure. Specifically, FIG. 9E shows a process of exchanging NPN information among a UE, a master node and a secondary node in a dual-connectivity case in which the UE performs NPN access with the secondary node, so that the secondary node can obtain the NPN information, so that the secondary node can make configuration adjustment and make a self-optimization decision.

Step 901E: the UE performs an NPN access process with the secondary node (or the CU of the secondary node and/or the DU of the secondary node).

Step 902E: the UE transmits NPN information to the master node (or the CU of the master node). The NPN information may be the aforementioned twelfth information. The NPN information may be transmitted through an SCGFailureInformation message.

Step 903E: the master node (or the CU of the master node) transmits NPN information to the secondary node (or the CU of the secondary node). The NPN information may be the aforementioned twelfth information. The NPN information may include all the information and/or part of the information in step 902E. The NPN information may be transmitted through a SgNB Modification Request and/or an SCG Failure Information Report message.

Step 904E: the CU of the secondary node transmits the NPN information to the DU of the secondary node. The NPN information may be the aforementioned twelfth information. The NPN information may include all the information and/or part of the information in step 903E. The NPN information may be transmitted through an Access And Mobility Indication message.

The master node (or the CU of the master node) and the secondary node (or the CU of the secondary node or the DU of the secondary node) can perform a self-optimization decision and/or update configurations based on the received NPN information.

FIG. 9F illustrates a schematic diagram of an aspect of a method for supporting non-public network self-optimization according to embodiments of the present disclosure. Specifically, FIG. 9F shows a process of exchanging NPN information among a UE, a master node and a secondary node in a dual-connectivity case in which the UE performs NPN access with the master node, so that the master node can obtain the NPN information, so that the master node can make configuration adjustment and make a self-optimization decision.

Step 901F: the UE performs an NPN access process with the master node (or the CU of the master node).

Step 902F: the UE transmits NPN information to the secondary node (or the CU of the secondary node). The NPN information may be the aforementioned twelfth information. The NPN information may be transmitted through a Master Cell Group failure information (MSGFailureInformation) message.

Step 903F: the secondary node (or the CU of the secondary node) transmits NPN information to the master node (or the CU of the master node and/or the DU of the master node). The NPN information may be the aforementioned twelfth information. The NPN information may include all the information and/or part of the information in step 902F. The NPN information may be transmitted through an RRC Transfer message.

Step 904F: the CU of the master node transmits NPN information to the DU of the master node. The NPN information may be the aforementioned twelfth information. The NPN information may include all the information and/or part of the information in step 903F. The NPN information may be transmitted through an Access And Mobility Indication message.

The master node (or the CU of the master node, or the DU of the master node) can perform a self-optimization decision and/or update configurations based on the received NPN information.

FIG. 9G illustrates a schematic diagram of an aspect of a method for supporting non-public network self-optimization according to embodiments of the present disclosure. Specifically, FIG. 9G shows a process of exchanging NPN information among a user, a node, a last serving node and an AMF, so that the last serving node can obtain NPN information, so that the last serving node can make configuration adjustment and make a self-optimization decision.

Step 901G: the UE performs an NPN access process with the last serving node (or the CU of the last serving node).

Step 902G: the UE performs RRC establishment and/or re-establishment with the node (or the CU of the node).

Step 903G: the UE transmits information indicating that the NPN information is available to the node (or the CU of the node), so as to inform the node (or the CU of the node) that the UE has the NPN information. The information indicating that NPN information is available may be the aforementioned tenth information. The information indicating that the NPN information is available may be transmitted through an RRCSetupComplete message.

Step 904G: the node (or the CU of the node) transmits a request for NPN information to the UE to request the UE to report NPN information. The request for NPN information may be the aforementioned eleventh information. The request for NPN information may be transmitted through a UEInformationRequest message.

Step 905G: the UE transmits NPN information to the node (or the CU of the node). The NPN information may be the aforementioned twelfth information. The NPN information may be transmitted through a UEInformationResponse message.

Step 906G: the node (or the CU of the node) transmits NPN information to the AMF. The NPN information may be the aforementioned twelfth information. The NPN information may include all the information and/or part of the information in step 905G. The NPN information may be transmitted through an Uplink RAN Configuration Transfer message.

Step 907G: the AMF transmits NPN information to the last serving node (or the CU of the last serving node). The NPN information may be the aforementioned twelfth information. The NPN information may include all the information and/or part of the information in step 906G. The NPN information may be transmitted through a Downlink RAN Configuration Transfer message.

The CU of the last serving node may also transmit all and/or part of the received NPN information to the DU of the last serving node.

The last serving node (or the CU of the secondary node, or the DU of the secondary node) can perform a self-optimization decision and/or update configurations based on the received NPN information.

FIG. 12A illustrates a schematic diagram of an aspect of a method for supporting non-public network self-optimization according to embodiments of the present disclosure. Specifically, FIG. 12A shows a process of exchanging an NPN activation result between two nodes, so that the first node can obtain information of an NPN activation result and make a self-optimization decision and/or update configurations, etc. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 1201A: the second node transmits an NPN capability activation result to the first node. The NPN capability activation result may be the aforementioned fourteenth information.

Step 1202A: the first node makes a self-optimization decision and/or updates configurations based on the obtained NPN capability activation result, etc. In some implementations, when the first node makes a handover decision for the UE, it selects a node that can support the NPN accessed by the UE as a handover target node.

FIG. 12B illustrates a schematic diagram of an aspect of a method for supporting non-public network self-optimization according to embodiments of the present disclosure. Specifically, FIG. 12B shows a process of exchanging an NPN activation request and an activation result between two nodes, so that the first node can request the second node to activate an NPN function, obtain an NPN activation result of the second node, and make a self-optimization decision and/or update configurations, etc. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other implementations, for example, the first node may be a gNB or gNB-CU or gNB CU-CP or en-gNB or eNB or ng-eNB, and the second node may be an AMF or SMF or MME.

Step 1201B: the first node transmits an NPN function activation request to the second node. The NPN function activation request may be the thirteenth information mentioned above.

Step 1202B: the second node transmits an NPN function activation result to the first node. The NPN function activation result may be the aforementioned fourteenth information.

Step 1203B: the first node makes a self-optimization decision and/or updates configurations based on the obtained NPN function activation result, etc. In some implementations, when the first node makes a handover decision for the UE, it selects a node that can support the NPN accessed by the UE as a handover target node.

In an implementation, the steps shown in FIG. 12 may occur after the steps shown in FIG. 5A or FIG. 5B. The first node knows the function and/or the on state of the second node through the steps of FIG. 5A and/or FIG. 5B, and it activates the NPN function of the second node by using the steps of FIG. 12.

Next, FIG. 10 illustrates a schematic diagram of a first node 1000 according to embodiments of the present disclosure.

As shown in FIG. 10, the first node (or first node device) 1000 according to embodiments of the present disclosure may include a transceiver 1010 and a processor 1020. The transceiver 1010 may be configured to transmit and receive signals. The processor 1020 may be coupled to the transceiver 1010 and may be configured to (e.g., control the transceiver 1010 to) perform the methods performed by a first node according to embodiments of the present disclosure.

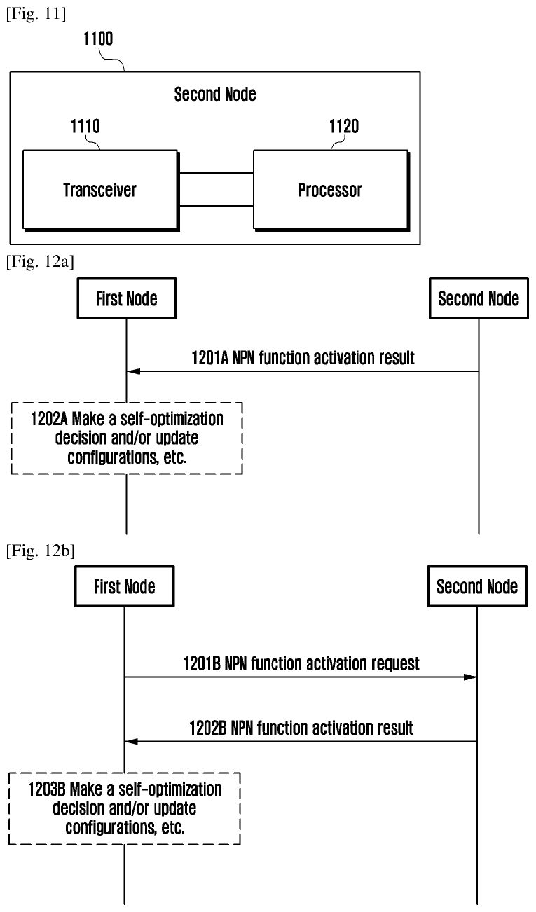

FIG. 11 illustrates a schematic diagram of a second node 1100 according to embodiments of the present disclosure.

As shown in FIG. 11, the second node (or second node device) 1100 according to embodiments of the present disclosure may include a transceiver 1110 and a processor 1120. The transceiver 1110 may be configured to transmit and receive signals. The processor 1120 may be coupled to the transceiver 1110 and may be configured to (e.g., control the transceiver 1110 to) perform a method performed by a second node according to embodiments of the present disclosure. The processor may also be called a controller.

Embodiments of the present disclosure also provide a computer-readable medium having stored thereon computer-readable instructions which, when executed by a processor, implement any method according to embodiments of the present disclosure.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program (s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1-15. (canceled)

16. A method performed by a user equipment (UE) in a wireless communication system, the method comprising:
receiving, from a base station, a request message to request a report message of non-public network (NPN) related information of the UE;
as a response to the request message, identifying the NPN related information of the UE; and
transmitting, to the base station, the report message including the NPN related information of the UE for self-optimization of the base station,
wherein the NPN related information of the UE includes at least one of a public land mobile network (PLMN) identification (ID) or a network ID.

17. The method of claim 16, wherein the report message further includes at least one of a random access report, a radio link failure (RIF) report, or a successful handover report.

18. The method of claim 16, wherein the NPN related information of the UE is used for the self-optimization of the base station.

19. The method of claim 16, wherein the NPN related information of the UE further includes at least one of NPN support capability information, NPN access requirement information of the UE, status situation of an NPN, load situation of the NPN, or an NPN function activation result.

20. A method performed by a base station in a wireless communication system, the method comprising:
transmitting, to a user equipment (UE), a request message to request a report message of non-public network (NPN) related information of the UE;
as a response to the request message, receiving, from the UE, the report message including the NPN related information of the UE for self-optimization of the base station; and
based on the NPN related information of the UE, performing the self-optimization of the base station,
wherein the NPN related information of the UE includes at least one of a public land mobile network (PLMN) identification (ID) or a network ID.

21. The method of claim 20, wherein the report message further includes at least one of a random access report, a radio link failure (RLF) report, or a successful handover report.

22. The method of claim 20, wherein the report message further includes at least one of an NPN failure report, an NPN report, or a continuous NPN failure report.

23. The method of claim 20, wherein the NPN related information of the UE further includes at least one of NPN support capability information, NPN access requirement information of the UE, status situation of an NPN, load situation of the NPN, or an NPN function activation result.

24. A user equipment (TIE) in a wireless communication system, the UE comprising:
a transceiver, and
a controller coupled with the transceiver configured to:
receive, from a base station, a request message to request a report message of non-public network (NPN) related information of the UE,
as a response to the request message, identify the NPN related information of the UE, and
transmit, to the base station, the report message including the NPN related information of the UE for self-optimization of the base station,
wherein the NPN related information of the UE includes at least one of a public land mobile network (PLMN) identification (ID) or a network ID.

25. The UE of claim 24, wherein the report message further includes at least one of a random access report, a radio link failure (RLF) report, or a successful handover report.

26. The IE of claim 24, wherein the NPN related information of the UE is used for the self-optimization of the base station.

27. The UE of claim 24, wherein the NPN related information of the UE further includes at least one of NPN support capability information, NPN access requirement information of the UE, status situation of an NPN, load situation of the NPN, or an NPN function activation result.

28. A base station in a wireless communication system, the base station comprising:
a transceiver, and
a controller coupled with the transceiver configured to:
transmit, to a user equipment (UE), a request message to request a report message of non-public network (NPN) related information of the UE,
as a response to the request message, receive, from the UE, the report message including the NPN related information of the UE for self-optimization of the base station; and
based on the NPN related information of the UE, perform the self-optimization of the base station,
wherein the NPN related information of the UE includes at least one of a public land mobile network (PLMN) identification (ID) or a network ID.

29. The base station of claim 28, wherein the report message further includes at least one of a random access report, a radio link failure (RLF) report, or a successful handover report.

30. The method of claim 28, wherein the report message includes at least one of an NPN failure report, an NPN report, or a continuous NPN failure report.

31. The method of claim 28, wherein the NPN related information of the UE further includes at least one of NPN support capability information, NPN access requirement information of the UE, status situation of an NPN, load situation of the NPN, or an NPN function activation result.
